(19) United States
(12) Patent Application Publication
(10) Pub. No.: US 2005/0200036 A1
(43) Pub. Date: Sep. 15, 2005

(54) Particle production apparatus

(76) Inventors: Ronald J. Mosso, Premont, CA (US); Xiangxin Bi, San Ramon, CA (US); James T. Gardner, Cupertino, CA (US); Sujeet Kumar, Fremont, CA (US); Samuel R. Phillip, Portola Valley, CA (US)

Correspondence Address: Patterson, Thuente, Skaar & Christensen, P.A., 4800 IDS Center, 80 South 8th Street, Minneapolis, MN, 55402-2100, US

(21) Appl. No.: 11/122,284

(22) Filed: May 3, 2005

Related U.S. Application Data
(62) Division of application No. 09/362,631, filed on Jul. 21, 1999.

(51) Int. Cl. B29B 9/00

(52) U.S. Cl. 264/14

(57) ABSTRACT

Improvements to chemical reaction systems provide for the production of commercial quantities of chemical products, such as chemical powders. The improved chemical reaction systems can accommodate a large reactant flux for the production of significant amounts of product. Preferred reaction systems are based on laser pyrolysis. Features of the system provide for the production of highly uniform product particles.

### CROSS REFERENCE TO RELATED APPLICATIONS

This application is a divisional of copending U.S. patent application Ser. No. 09/362,631 to Mosso et al., entitled “Particle Production Apparatus,” incorporated herein by reference.

### BACKGROUND OF THE INVENTION

The invention relates to the production of particles by the reaction of chemical compounds. More particularly, the invention relates to the formation of particles by chemical reaction within a reaction chamber designed for the production of commercial quantities of product.

There has been growing demand for solid state materials with dimensions in the range from 1 to 100 nanometers (nm). These nanoscale particles have been found to exhibit unusual chemical, mechanical, electrical, magnetic and optical properties that are different from the corresponding properties of the bulk material and conventional powders. These unusual properties can be exploited in a number of applications.

One advantage of nanoparticles relative to larger particles is the increased surface area for a given weight of material. The surface area per weight of nanoscale particles can be one or two orders of magnitude greater than the surface area per weight of conventional powders. This increase in surface area is desirable for a variety of applications such as those involving catalysis, hydrogen storage and electrical capacitors.

Advances in a variety of fields have created a demand for many types of new materials. In particular, a variety of chemical powders can be used in many different processing contexts. Specifically, there is considerable interest in the application of ultrafine or nanoscale powders that are particularly advantageous for a variety of applications involving small structures or high surface area materials. This demand for ultrafine chemical powders has resulted in the development of sophisticated techniques, such as laser pyrolysis, for the production of these powders.

### SUMMARY OF THE INVENTION

In a first aspect, the invention pertains to a particle production apparatus comprising:
a reaction chamber;
a reactant inlet defining a reactant path through the reaction chamber, the reactant inlet being connected to a reactant delivery system; and
optical elements defining a light path through the reaction chamber that intersects the reactant path, where the light path through the reaction chamber does not follow a single straight line path.

In another aspect, the invention pertains to a particle production apparatus comprising:
a reaction chamber;
a reactant inlet defining a reactant path through the reaction chamber, the reactant inlet being connected to a reactant delivery system;
a light source; and
optical elements directing a light beam from the light source through the reaction chamber that intersects the reactant path, the optical elements comprising a focusing element and a collimating element.

In a further aspect, the invention pertains to a method of producing a collection of nanoscale particles having a selected average particle diameter. In particular, the method includes reacting a reactant stream within a reaction chamber with a light beam, where the average time of flight of the reactant stream through the light beam is selected by changing the properties of the light beam to produce the selected average particle diameter.

Moreover, the invention pertains to a particle production system comprising:
a plurality of reactant inlets configured to direct a reactant stream toward one or more product outlets; and
a particle collection apparatus connected to the one or more product outlets to collect the product particles generated by the reactants from the plurality of reactant inlets.

In addition, the invention pertains to a method of producing a mixture of particles, the method comprising:
supplying different reactant streams to two reactant inlets;
reacting the distinct reaction streams to produce two product particle streams, each with different product particle compositions; and
directing the two product particle streams to a single particle collector such that a mixture of product particles are collected.

In another aspect, the invention pertains to a particle production apparatus comprising:
a reaction chamber;
a reactant inlet generating a reactant stream through the reaction chamber, the reactant inlet being connected to a reactant delivery system;
optical elements defining an optical path through the reaction chamber, where the optical path intersects the reactant stream at a reaction zone; and
a spectrometer connected to the reaction chamber by way of suitable optics to measure optical properties of the reactant/product stream.
   A method of selecting reaction conditions can be based on this particle production apparatus. The method includes selecting the reaction conditions to produce a selected measurement on a spectrometer in a particle production apparatus, wherein the selected measurement is correlated with a reaction product property.

In a further aspect, the invention pertains to a particle production apparatus comprising:
a reaction chamber having a reactant inlet connected to a reactant delivery system, the reactant chamber having a plurality of shielding gas outlets connected to an inert gas delivery system such that inert gas is delivered along walls of the reaction chamber as a thin film; and
a particle collection apparatus connected to the product outlet.

In addition, the invention pertains to a particle production system comprising:
a reaction chamber having a reactant inlet connected to a reactant delivery apparatus oriented to produce a reactant stream within the reactant chamber;
an optical element positioned to direct a light beam along a light path through the reaction chamber intersecting the reactant stream; and
a tapered tube extending from the reaction chamber along the light path, the tube supporting the optical element, and the tube having a smaller cross sectional area at the connection to the reaction chamber relative to the cross sectional area of the tube at the optical element.

In another aspect, the invention pertains to a particle production system comprising:
a reaction chamber having a reactant inlet connected to a reactant delivery apparatus oriented to produce a reactant stream within the reactant chamber; and
optical elements positioned to direct two approximately parallel light beams, where the reactant stream is intersected by at least one light beam.

Moreover, the invention pertains to a particle production system comprising:
a light source;
optical elements to split the light beam from the light source into two beams; and
at least two reaction chambers, one of the light beams being directed to one reaction chamber and the other light beam being directed to the other reaction chamber.

### BRIEF DESCRIPTION OF THE DRAWINGS

FIG. 1 is a schematic, perspective view of a reaction system including preferred subsystems.

FIG. 2 is a side view of a reactant delivery apparatus for the delivery of vapor reactants to two reactant inlets of the laser pyrolysis apparatus of FIG. 2, where modification for the delivery of vapor reactants to a single reactant inlet is indicated in phantom lines and an optional element to assist with mixing is shown in the insert.

FIG. 3 is a side view of a reactant delivery apparatus for the delivery of two aerosol reactants through two reactant inlets into the reaction chamber.

FIG. 4 is a schematic, side view of another alternative embodiment of a reactant delivery apparatus for the delivery of an aerosol reactant into the reaction chamber.

FIG. 5 is a side view of a reactant delivery system that produces an aerosol within the reaction chamber as part of the reactant stream.

FIG. 6 is a side view of a reactant delivery system designed to produce and to mix two aerosols within the reaction chamber.

FIG. 7 is a schematic, perspective view of an elongated reaction chamber, with hidden structure depicted using phantom lines.

FIG. 8 is a schematic, perspective view of a reaction chamber extended in two dimensions, where hidden structure is depicted using phantom lines.

FIG. 9 is a sectional view of the reaction chamber of FIG. 8 taken along line 9-9.

FIG. 10 is a schematic, perspective view of a cylindrical reaction chamber, where hidden structure is depicted using phantom lines.

FIG. 11 is a sectional view of the reaction chamber of FIG. 10, taken along line 11-11.

FIG. 12 is a schematic, perspective view of a wedge shaped reaction chamber, where hidden structure is depicted using phantom lines.

FIG. 13 is a sectional view of the reaction chamber of FIG. 12, taken along line 13-13.

FIG. 14 is a top, plan view of an elongated reaction chamber with two reactant inlets.

FIG. 15 is a schematic, perspective view of a reaction chamber extended in two dimensions having a moveable reactant inlet nozzle, where hidden structure is depicted using phantom lines.

FIG. 16 is a schematic, perspective view of an elongated reaction chamber where the reactant stream propagates in a direction at an angle with respect to the light beam path, and where hidden structure is depicted using phantom lines.

FIG. 17 is a schematic, perspective view of a reaction chamber with a reactant inlet and an outlet meeting commensurate with the walls of the reaction chamber.

FIG. 18A is a fragmentary, sectional view through the wall of a reaction chamber adapted with a thin film shielding gas delivery approach.

FIG. 18B is a fragmentary, perspective view of the joining of the inner walls of the reaction chamber walls shown in FIG. 18A.

FIG. 19A is a fragmentary, sectional view through the wall of a reaction chamber with an alternative embodiment adapted for a thin film shielding gas delivery.

FIG. 19B is a fragmentary, perspective view of the joining of the inner walls of the reaction chamber of the reaction chamber walls shown in FIG. 19A.

FIG. 20 is a fragmentary, section view of the wall of the reaction chamber with a porous inner wall for the delivery of inert gas from an inert gas channel within the wall.

FIG. 21A is a fragmentary sectional view of the wall of the reaction chamber with notches in the inner wall for the delivery of inert gas into the reaction chamber from an inert gas channel within the wall.

FIG. 21B is a fragmentary side view of a section of an inner, reaction chamber wall with notches for the delivery of inert gas.

FIG. 22A is a fragmentary, sectional view of another alternative embodiment of the wall of the reaction chamber configured for inert gas delivery, in which the inner wall includes wall segments that are connected by spacers to form the inner wall. The cross section is taken through a section of chamber wall along a direction parallel to reactant flow in the chamber.

FIG. 22B is a fragmentary sectional view of the chamber wall shown in FIG. 22A, where the section is taken along line B-B.

FIG. 23 is a schematic, perspective view of an elongated reaction chamber in which the light beam path extends from the main chamber along extension tubes.

FIG. 24 is a fragmentary, perspective view of a light beam path through a tapered tube into the main chamber.

FIG. 25 is a schematic, perspective view of a light beam path, intersecting with a reactant stream, generated with a cylindrical lens window.

FIG. 26 is a schematic perspective view of a light beam path with an expanding spherical lens and collimating optics leading to a cylindrical lens.

FIG. 27A is a schematic, top view of a light beam path split by a beam splitter and directed with a reflector.

FIG. 27B is a fragmentary, sectional view of a light beam path displaced and reflected in the incident direction with two reflectors; the cross section is taken through the light beam path.

FIG. 28A is a schematic, side view of a light beam path having a telescopic lens system to change the thickness of the light beam.

FIG. 28B is a schematic, top view of the light beam path and telescopic lens system of FIG. 28A.

FIG. 29 is a schematic, perspective view of a reaction system with two light sources.

FIG. 30 is a schematic perspective view of a reaction chamber mounted on an angle such that a curved section is not needed between the reaction chamber and the collection apparatus. Hidden structure of the reactant inlet is shown in phantom lines.

FIG. 31 is a perspective view of a reaction chamber elongated in one dimension and connected to a collection apparatus with a filter.

FIG. 32 is a sectional view of the apparatus of FIG. 31, taken along line 32-32.

FIG. 33 is a side view of a collection apparatus for continuous collection of particles connected to a reaction chamber, where part of the structure of the apparatus has been removed to expose hidden structure.

FIG. 34 is a schematic, side view of three reaction chambers connected to a manifold leading to a collection apparatus.

FIG. 35 is a schematic, side view of three reaction chambers connected to a manifold leading to a collection apparatus, where the reaction chambers are oriented such that a single light beam passes through the three reaction chambers.

FIG. 36 is a fragmentary schematic, sectional view of a reaction chamber with a mass spectrometer and a particle size analyzer connected to the reaction chamber to sample the reactant stream and product particles, respectively, where the cross section is taken roughly through the center of the chamber. An enlargement of an embodiment of the sampler is shown in the insert.

FIG. 37 is a schematic, perspective view of a reaction chamber connected to two types of spectrometers.

### DETAILED DESCRIPTION OF THE PREFERRED EMBODIMENTS

A variety of features can be incorporated into the construction of a reaction system, such that the reaction system is suitable for the efficient production of commercial quantities of chemical powders. Some of these improved features relate specifically to chamber design while others relate to control of the reaction process. The general requirements for the production of commercial quantities of materials include a relatively large flux of reactants and a suitable approach for the collection of the products/particles. Thus, efficient delivery of reactants and efficient removal or product are part of the efficient overall reaction process. While producing a commercial quantity of chemical powders, product particles with highly uniform properties are desirable for certain applications, such as chemical-mechanical polishing. In preferred embodiments, the reaction systems are used for the production of nanoscale particles.

Generally, the reaction system includes a reactant delivery apparatus, a reaction chamber, an energy source, a product collection apparatus, and a control system. The energy source can be in the form of a source of electromagnetic radiation, including, for example, a source of infrared light, visible light, and/or ultraviolet light. A reaction chamber elongated in one dimension and having additional corresponding modifications in other components is described in published PCT Application WO 98/37961 to Bi et al., entitled “EFFICIENT PRODUCTION OF PARTICLES BY CHEMICAL REACTION,” incorporated herein by reference. Alternative reaction chamber designs for maintaining a high reactant flux while keeping chamber contamination low are described below. Shielding gas generally is used to blanket the reactant stream flowing through the reaction chamber to reduce the incidence of chamber contamination. Inert gas can also be a part of obtaining efficient reactant transport.

The collection apparatus can include a manifold connected to outlets from a plurality of reaction chambers such that particles can be collected simultaneously from the plurality of reaction chambers. The different reaction chambers can be configured to produce different product particles such that the different particles are mixed within the manifold. The plurality of reaction chambers connected to the manifold can be arranged such that a single light beam passes through more than one reaction chamber.

While the improved reaction chamber can be used for a variety of reaction processes, as described further below, in preferred embodiments the reaction system is used to perform laser pyrolysis. Laser pyrolysis involves an intense light source to rapidly heat the reactants to drive the chemical reaction. For laser pyrolysis, the reactant stream includes one or more reactants as well as a separate light absorbing gas, if the reactants themselves do not absorb light sufficiently. The reaction product is quenched rapidly after the reactant/product stream leaves the light beam. In part due to the nonequilibrium nature of the laser pyrolysis process, highly uniform product particles are produced.

For the performance of laser pyrolysis, a suitable optical configuration preferably is integrated into the reaction chamber such that the light beam intersects with all or most of the reactant stream. Thus, a preferred configuration of the optical path necessarily depends on the configuration of the reaction chamber, and visa versa. The reaction zone is roughly the region of intersection of the light beam and the reactant stream.

The chemical reactions in the reaction chamber effectively take place in a vapor state although particles can be present, both initially in the reactant stream and subsequently formed as reaction products. The reactants can be delivered as either gases and/or aerosols. The use of an aerosol delivery apparatus provides for the use of a wider range of reactants. Liquids for delivery as an aerosol include liquid solutions, neat liquids and dispersions. For example, solid or liquid reactants can be dissolved into a solvent and delivered as an aerosol. Similarly, solids can be dispersed in a liquid for delivery as an aerosol. If a solvent is used to form an aerosol, the solvent generally is rapidly evaporated during or prior to the reaction.

The reaction systems described herein involve continuous flow systems. Generally, a flow is established between the reactant delivery system, the reaction chamber and the product collection apparatus. The particles can be collected in a batch mode or in a continuous mode. In batch mode, the reaction can be continued until the particle collection apparatus becomes full. In continuous mode, product can be harvested from the collection apparatus while the reaction continues to produce additional product.

In preferred embodiments, product particles are highly uniform. Thus, preferred embodiments of the reaction system maintain the uniformity of the product particles while providing for the production of commercial quantities of materials. Furthermore, properties within the reaction chamber can be controlled precisely to ensure the production of materials that are more highly uniform than was possible without improved approaches for controlling reaction conditions. In particular, approaches are described to carefully control the uniformity of the light beam, the reaction temperature, the chamber pressure, the reactant flux and the light intensity.

1. Reaction System

Reaction systems are described that are suitable for the synthesis of chemical powders. In general, the reaction systems can be used to perform effectively “gas phase” reactions where the reactants are vapors and/or aerosols. The aerosols include particles and/or droplets dispersed and entrained in a gas flow. The reaction systems are particularly useful for performing laser pyrolysis for the production of nanoscale particles. In a laser pyrolysis apparatus, a light absorbing compound, possibly one or more of the reactants themselves or a solvent/dispersant, absorbs light and rapidly transfers heat to the reactants. Any intense light source can be used, although lasers are preferred. The reactants rapidly reach very high temperatures. Solvent, if any, preferably is rapidly vaporized. Laser pyrolysis apparatuses are particularly suitable for the production of particles having an average diameter less than about 1000 nm, and more preferably from about 5 nm to about 500 nm.

Alternatively, the reaction system can be part of a flame production apparatus such as the apparatus described in U.S. Pat. No. 5,447,708 to Helble et al., entitled “Apparatus for Producing Nanoscale Ceramic Particles,” incorporated herein by reference. Furthermore, the reaction system can be part of a thermal reaction chamber such as the apparatus described in U.S. Pat. No. 4,842,832 to Inoue et al., “Ultrafine Spherical Particles of Metal Oxide and a Method for the Production Thereof,” incorporated herein by reference.

The reaction systems described herein are designed for the efficient production of commercial quantities of particles. Various embodiments of high production rate reaction systems are described in copending and commonly assigned patent application Ser. No. 08/808,850 now U.S. Pat. No. 5,958,348, entitled “Efficient Production of Particles by Chemical Reaction,” filed on Feb. 28, 1997, incorporated herein by reference. Alternative and complimentary embodiments are described herein.

Laser pyrolysis has been performed generally with gas phase reactants. The use of exclusively gas phase reactants is somewhat limiting with respect to the types of precursor compounds that can be conveniently used. Thus, techniques have been developed to introduce aerosols containing reactant precursors into laser pyrolysis chambers. The aerosol atomizers can be broadly classified as ultrasonic atomizers, which use an ultrasonic transducer to form the aerosol, electrical atomizers, which use electric fields to form the aerosol, or as mechanical atomizers, which use energy from one or more flowing fluids (liquids, gases, or supercritical fluids) themselves to form the aerosol. Uniformity of the aerosol assists with the production of a more uniform product, for example, nanoparticles with a narrow size distribution.

Improved aerosol delivery apparatuses for reactant systems are described further in copending and commonly assigned U.S. patent application Ser. No. 09/188,670, now U.S. Pat. No. 6,193,936 to Gardner et al., entitled “Reactant Delivery Apparatuses,” incorporated herein by reference. These aerosol delivery systems can be adapted for use in reaction systems not involving laser pyrolysis. Approaches are also described therein for the adaptation of aerosol delivery by a variety of approaches with a reaction chamber elongated in one dimension in the plane perpendicular to a reactant stream. Some of these approaches include, for example, using an elongated nozzle opening, placing columns of gas jets adjacent the aerosol nozzle, employing a plurality of aerosol nozzles and applying a combination thereof.

The relevant components of a reaction system of interest are shown schematically in FIG. 1. Reaction system 100 includes a reactant delivery apparatus 102, a reaction chamber 104 and a collection apparatus 106. For the performance of laser pyrolysis in preferred embodiments, reaction chamber 104 has a light beam path 108 intersecting with a reactant stream. Light beam path 108 originates from a light source 110. A controller 112 is used to monitor the reaction parameters and assist with control of the reaction parameters. Approaches for directly monitoring the reaction with a spectrometer are described below.

2. Reactant Delivery Apparatuses

Reactant delivery apparatus 102 is used to deliver gaseous and/or aerosol reactants into reaction chamber 104 in the form of a confined reactant stream. The reactant stream is generally configured to correspond to the structure of reaction chamber 104. The reactant flow stream preferably fills most of the cross sectional area of the reaction chamber such that there is little volume of the reaction chamber that is not involved in the reactant/product flow. The reactant stream preferably is surrounded by shielding gas to assist with confining the reactant stream. If the reactant stream fills most of the cross sectional area of the reaction chamber only a small volume of shielding gas is needed. Preferred structures for reaction chamber 104 are described further below. General features of reactant delivery apparatus 102 can be described without reference to the particular structure of reaction chamber 104.

In embodiments for performing the reaction by laser pyrolysis, the reactant stream includes one or more reactants, optional inert compounds and optional light absorbing compounds. A separate light absorbing compound is not needed if one or more of the reactants absorb light sufficiently. The reactant stream enters the reaction chamber at a reactant inlet, and the reactant/product stream, including any unreacted reactants, inert gases, product and shielding gas, exits the reaction chamber at an outlet.

Laser pyrolysis is performed with one or more reactants. Each reactant generally contributes one or more atoms to the final product. The reaction can be exothermic overall. In traditional laser pyrolysis, the heat contributed by the laser is sufficient to stimulate the reactants to initiate the reaction. The composition of the reactant stream is adjusted such that the atoms recombine to form the desired products. The rapid quench of the reaction as the reactant stream leaves the reaction zone produces a highly uniform product.

Various embodiments of reactant delivery apparatus 102 are suitable for the delivery of gaseous and/or aerosol reactants and other compounds along the reactant stream. Reactants and other compounds within the reactant stream can be mixed prior to introduction into the reaction chamber. Then, the reactants can be delivered through a single reactant inlet as a mixed stream of compounds.

Alternatively, the reactant stream can be completed within the reaction chamber by the mixture of two or more compounds, e.g., reactants. This can be accomplished through the use of a reactant delivery apparatus 102 with two reactant inlets for the passage of reactants to form a reactant stream in reaction chamber 104. Separate streams of compounds are generated by the inlets for mixing within the chamber. The reactant inlets form part of an injection nozzle for directing reactants into the reaction chamber along the reactant stream. The use of multiple inlets can be particularly advantageous when the reactants are violently reactive. The use of multiple inlets for strongly reactive reactants is described further in copending and commonly assigned U.S. patent application Ser. No. 09/266,202 to Reitz et al., entitled “Zinc Oxide Particles,” incorporated herein by reference. Similarly, one or more reactants can be combined with a shielding gas such that a portion of the reactant in the shielding gas mixes with the remaining portion of the reactant stream within the reaction chamber.

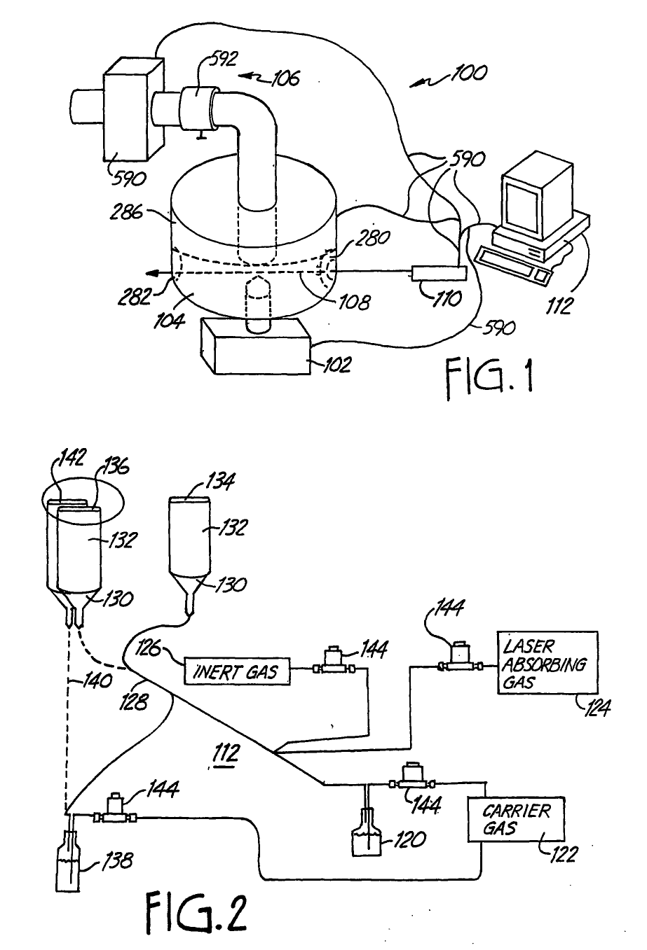

Referring to FIG. 2, a first embodiment 112 of reactant delivery apparatus 102 includes a source 120 of a first reactant compound. For liquid or solid reactants, a carrier gas from carrier gas source 122 can be introduced into first reactant source 120 to facilitate delivery of the reactant. The carrier gas from source 122 preferably is either a light (e.g., infrared) absorber or an inert gas and is preferably bubbled through a liquid reactant compound or delivered into a solid reactant delivery system. The quantity of reactant vapor in the reaction zone is roughly proportional to the flow rate of the carrier gas. A liquid or solid reactant can be heated to increase its vapor pressure. Similarly, portions of reactant delivery apparatus 102 can be heated to inhibit the deposition of reactant compound on the walls of the delivery system.

Alternatively, carrier gas can be supplied directly from light absorber source 124 or inert gas source 126, as appropriate. The gases from the first reactant source 120 are mixed with gases from light absorber source 124 and/or inert gas source 126 by combining the gases in a single portion of tubing 128. The gases are combined a sufficient, but possibly relatively short, distance from reaction chamber 104 such that the gases become well mixed prior to their entrance into reaction chamber 104. The combined gas in tube 128 passes through a duct 130 into channel 132, which is in fluid communication with channel opening 134 (or 136, as shown in phantom lines).

A second reactant can be supplied from second reactant source 138, which can be a liquid reactant delivery apparatus, a solid reactant delivery apparatus, a gas cylinder or other suitable container or containers. If second reactant source 138 delivers a liquid or solid reactant, carrier gas from carrier gas source 122 or alternative source can be used to facilitate delivery of the reactant. As shown in FIG. 2, second reactant source 138 delivers a second reactant to duct 130 by way of tube 128. Alternatively, second reactant source 138 can deliver the second reactant to tube 140 for delivery through a second reactant inlet 142, as depicted with phantom lines in FIG. 2.

With alternative delivery through channel openings 136, 142, the first and second reactants are mixed within the reaction chamber after exiting from the reactant inlets. If more than two reactants are used, the additional reactants can similarly be delivered through a single channel inlet 134, through two openings 136, 142, or through more than two reactant inlets, as appropriate or desired. Mass flow controllers 144 can be used to regulate the flow of gases within the reactant delivery system of FIG. 2.

As noted above, the reactant stream can include one or more aerosols. The aerosols can be formed within reaction chamber 104 or outside of reaction chamber 104 prior to injection into reaction chamber 104. If the aerosols are produced prior to injection into reaction chamber 104, the aerosols can be introduced through reactant inlets comparable to those used for gaseous reactants, such as leading to channel opening 134 in FIG. 2.

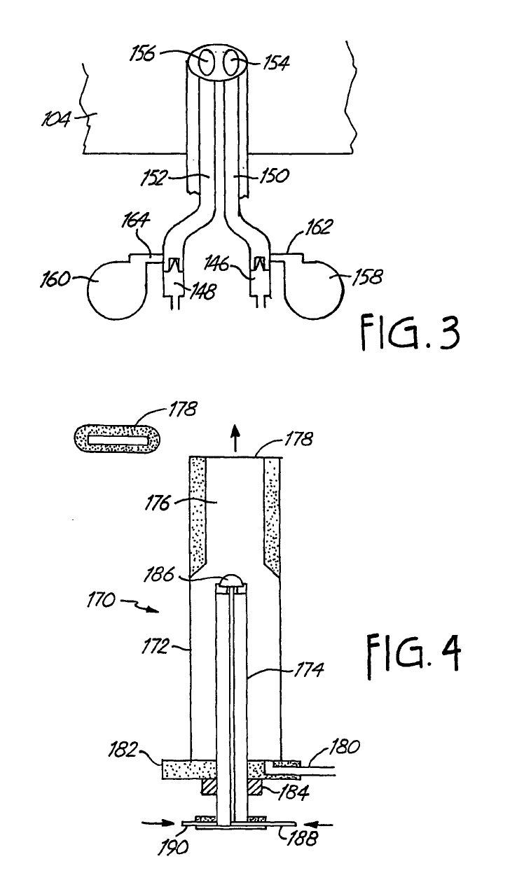

Referring to FIG. 3, an alternative embodiment of reactant delivery apparatus 102 is shown for delivery of two aerosol reactants. Aerosol generators 146, 148 deliver aerosol into delivery tubes 150, 152, respectively. Delivery tubes 150, 152 deliver reactants to two openings 154, 156, respectively. Aerosol generators 146, 148 can operate based on a variety of principles. For example, the aerosol can be produced with an ultrasonic nozzle, with an electrostatic spray system, with a pressure-flow or simplex atomizer, with an effervescent atomizer or with a gas atomizer where liquid is forced under significant pressure through a small orifice and fractured into particles by a colliding gas stream. Suitable ultrasonic nozzles can include piezoelectric transducers. Ultrasonic nozzles with piezoelectric transducers and suitable broadband ultrasonic generators are available from Sono-Tek Corporation, Milton, N.Y., such as model 8700-120. Suitable aerosol generators are described further in copending and commonly assigned, U.S. patent application Ser. No. 09/188,670, now U.S. Pat. No. 6,193,936 to Gardner et al., entitled “Reactant Delivery Apparatuses,” incorporated herein by reference.

Reactant gases, inert gases and/or light absorbing gases can be supplied according to any of a variety of configurations into delivery tubes 150, 152, as desired, by way of gas sources 158, 160 and gas supply tubes 162, 164. Alternatively, one of the aerosol generators can be eliminated such that the reactant delivery apparatus delivers an aerosol and a gaseous reactant through openings 154, 156, respectively.

Alternative embodiments can be based on variation of the embodiments of FIG. 3 to deliver reactants by way of a single channel opening 134. In these embodiments, there is a single delivery tube. The second aerosol generator can be eliminated or configured to deliver an aerosol into the same delivery tube as the first aerosol generator. Thus, these alternative embodiments can be used to deliver into reaction chamber 104, an aerosol reactant and a gaseous reactant, two aerosol reactants or more than two reactants with one or more aerosols through a single channel opening 134.

Referring to FIG. 4, another embodiment 170 of the reactant supply system 102 can be used to supply an aerosol. Reactant supply system 170 includes an outer nozzle 172 and an inner nozzle 174. Outer nozzle 172 has an upper channel 176 that leads to a rectangular outlet 178 at the top of outer nozzle 172, as shown in the insert in FIG. 4. Rectangular outlet 178 has suitable dimensions based on the size of the reaction chamber. Outer nozzle 172 includes a drain tube 180 in base plate 182. Drain tube 180 is used to remove condensed aerosol from outer nozzle 172. Inner nozzle 174 is secured to outer nozzle 171 at fitting 184.

Inner nozzle 174 is a gas atomizer, which is available from Spraying Systems, Wheaton, Ill., such as model number 17310-12-1x8jj. The inner nozzle has about a 0.5 inch diameter and a 12.0 inch length. The top of the nozzle is a twin orifice internal mix atomizer 186 (0.055 in. gas orifice and 0.005 in. liquid orifice). Liquid is fed to the atomizer through tube 188, and gases for introduction into the reaction chamber are fed to the atomizer through tube 190. Interaction of the gas with the liquid assists with droplet formation.

Outer nozzle 182 and inner nozzle 184 are assembled concentrically. Outer nozzle 182 shapes the aerosol generated by inner nozzle 184 such that it has a flat rectangular cross section. In addition, outer nozzle 182 helps to achieve a uniform aerosol velocity and a uniform aerosol distribution along the cross section. Outer nozzle 182 can be reconfigured for different reaction chambers. The height of outer nozzle 182 relative to a radiation/laser beam can be adjusted to produce spray characteristics that result in desired particle properties.

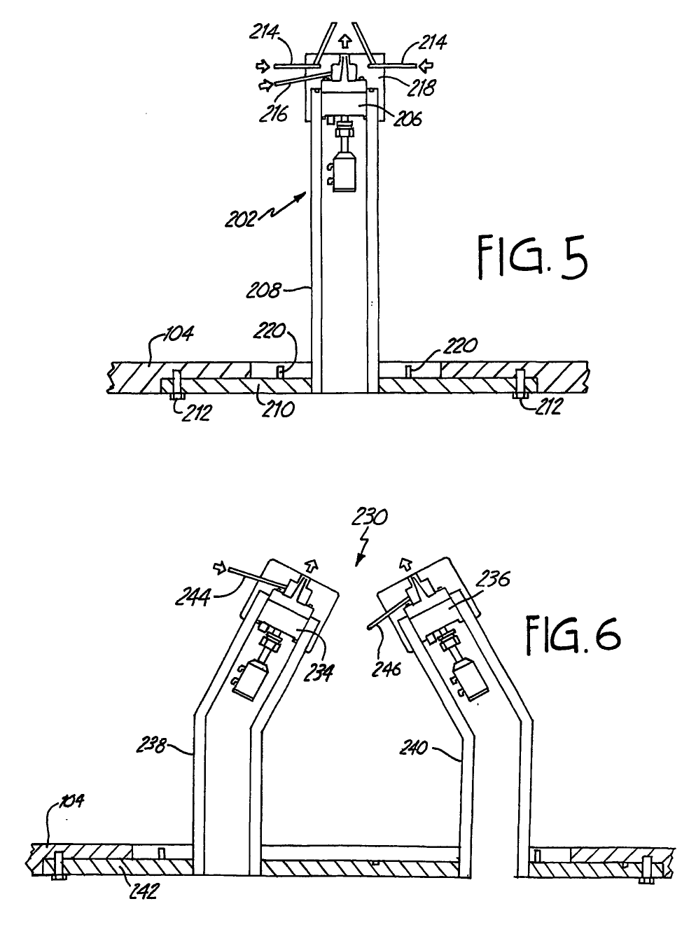

Referring to FIG. 5, an alternative embodiment 202 of reactant delivery apparatus 102 delivers an aerosol reactant directly into reaction chamber 104. Aerosol generator 206 is supported by mount 208. Mount 208 is attached to base plate 210. Base plate 210 is secured to reaction chamber 104 with bolts 212. Optional gas delivery tubes 214 can be used to deliver a gaseous reactant, inert gas and/or light absorbing gas for mixture with aerosol reactant from aerosol generator 206. The number of gas delivery tubes 214 can be adjusted, as desired, with four tubes symmetrically distributed around the aerosol generator being one preferred embodiment.

Carrier gas, i.e., an inert gas and/or a light absorbing gas, or a second reactant compound can be delivered by carrier gas tube 216 for delivery with the aerosol. Gas delivery tubes 214 and carrier gas tubes 216 can be supported by a cap 218 on top of mount 208. Gas delivery tubes 214 and carrier gas tube 216 can be connected with a stainless steel tube or the like by way of ports 220 to gas sources outside of reaction chamber 104. With the configuration shown in FIG. 5, multiple reactants can be delivered by way of aerosol generator 206 if the reactants are mixed within a liquid that is used to produce the aerosol.

Another alternative embodiment 230 of the reactant delivery apparatus 102 is depicted in FIG. 6. In this embodiment, aerosol generators 234, 236 are connected to mounts 238, 240, respectively. Mounts 238, 240 are secured to a base plate 242, which is secured to reaction chamber 104. Mounts 238, 240 are angled such that the aerosols generated by aerosol generators 234, 236 mix within reaction chamber 104. Carrier gases and/or additional reactants can be delivered along with the aerosols using carrier gas tubes 244, 246.

A variety of configurations of the reactant delivery apparatus 102 were described by reference to FIGS. 2-6. Additional embodiments for the reactant delivery apparatus for a particular reaction chamber 104 can be constructed based on the disclosure herein to achieve desired objectives.

3. Reaction Chamber

The reactant inlet or inlets generally are configured to produce a reactant stream that covers a significant fraction of the cross sectional area of the reaction chamber 104. Reaction chamber 104 can have a variety of designs and features. In preferred embodiments, reaction chamber 104 provides for the production of commercial quantities of product particles. To produce commercial quantities of particles efficiently, the apparatus must produce particles at a high rate, preferably greater than about 1kg per hour. A large reactant flux and a high yield are needed to reach these high production rates. The design of reaction chamber 104 must account for a high reactant flux and high product yield.

Reaction chamber 104 can be produced from any reasonable, sturdy and inert materials. Preferred materials include corrosion resistant metals, such as stainless steel. Other preferred materials for reaction chamber 104 include ceramics such as alumina and quartz, plastics such as polypropylene, polyethylene and polyvinylidene fluoride, and glasses such as borosilicate glasses. Plastic materials are generally appropriate for synthesizing materials at more moderate temperatures. Glasses and ceramics are particularly suitable when high temperature materials are synthesized. The surfaces of the reaction chamber preferably are smooth for easy cleaning. The surfaces of the reaction chamber can be coated to impart corrosion resistance and/or to make the surfaces easier to clean. Suitable coatings include, for example, polytetrafluoroethylene and epoxy based materials.

As noted above, the reaction chamber can be heated to reduce or eliminate condensation of reactants and products (such as water) onto the chamber walls. In addition, the chamber can be heated to reduce forces driving product particles toward cooler chamber walls associated with the Soret effect. Heating can prevent condensation by other effects such as low velocities in the flow field near the chamber walls. Empirical adjustments can be made to obtain the desired level of heating to reduce or eliminate the Soret effect. Preferably, the temperature of the delivery channels of the reactant delivery system, the inside of the reaction chamber and the collection system are at approximately the same temperatures to avoid condensation.

For large fluxes of reactants, heating due to the reaction can result in the overheating of the walls, which can damage the reaction chamber. Thus, insulation and/or cooling of the walls may be desirable. Liquid cooling of the reaction chamber can be accomplished by submerging the reaction chamber in a circulating liquid bath or connecting a water, oil or other liquid bath to a series of tubes flowing along the surface or within the reaction chamber. In preferred embodiments, the chamber is configured for heating and cooling to obtain a desired chamber wall temperature at different times during the reaction process and different reaction conditions.

Also, electrostatic repulsion can be used to reduce or eliminate contamination of the chamber walls with particles. Some particles may be charged from the reaction process. In this case, the chamber walls can be given a like charge to repel the particles. Alternatively, the particles can be charged. Referring to FIG. 1, high voltage electrodes 280, 282 can be used to charge the particles. Electrodes 280, 282 have opposite charges from each other. Electrodes 280, 282 preferably conform to the walls of the chamber to avoid distorting the flow through the chamber, and electrodes 280, 282 generally are separated from the chamber walls by an electrically insulating layer to prevent a short circuit of the electrodes. Negative electrode 280 can be heated to facilitate the projection of an electron beam. The chamber walls separate from electrodes 280, 282, or at least the upper portion 286 of the chamber, can be given a low charge opposite of the particle charge. For example, if the particles are given a negative charge by electrodes 280, 282, the upper chamber walls 286 can be given a negative charge to repel the particles. The charge on the walls to repel the particles should be low such that no charge is transferred to the particles.

Referring to FIG. 7, reaction chamber 104 generally includes a main chamber 300, a reactant inlet or inlets 302, a product outlet or outlets 304 and other optional features, such as optical elements and measurement devices. In preferred embodiments involving the performance of laser pyrolysis, reaction chamber 104 includes a light beam path 306 defined by appropriate optical elements, described further below. The optical elements include at least window 308 that provides for the introduction of light from a light source, and generally optical element 310 that provides for redirection or absorption of the light beam after traversing the main chamber. Reaction chamber 104 can include one or more optional observation/measurement ports 312.

Reactant inlet 302, or the specific embodiments described above for the delivery of a reactant stream, can be located at the entrance into nozzle 314. In some preferred embodiments, nozzle 314 can be positioned within chamber 300 to adjust the distance from inlet 302 to the light beam path 306. The distance from the opening of nozzle 314 to the light beam preferably is small such that the reactants do not have a significant opportunity to spread prior entrance into the reaction zone. An inert shielding gas generally is also used to confine the reactant stream within the reaction chamber.

Similarly, outlet 304 is located at the end of a channel 316 that leads out from reaction chamber 300 preferably at a relatively short distance from light path 306. Channel 316 can extend into main chamber 300 to reduce the distance from light beam path 306. Channel 316 leads to conduit 318 that forms part of collection apparatus 106.

To obtain a desired flow, the design of channel 316 preferably depends on the rate and volume of gas exiting the reaction zone. In particular, a desired flow has no recirculation to the reaction zone, no wall contamination and low consumption of inert gases and excess reagents. The flow is also affected by the induced draft from a pressure differential within the system that is used to control the flow through the reaction chamber and the collector system. In addition the flow is also affected by the specific volume changes due to the reaction, in which heating tends to result in an increase in specific volume while particle formation tends to result in a decrease in specific volume due to densification.

A reactant stream originates from reactant inlet 302. In order to provide for a desired production rate, reactant inlet 302 generally covers a reasonably large area since it may not be desirable to increase reactant density to arbitrarily large values. In addition, the cross section of the reactant stream at the point of intersecting the light beam should roughly correspond to the cross section of the light beam. Similarly, main chamber 300 should be shaped such that the cross section of the reactant stream covers a significant fraction of the cross sectional area of the reaction chamber. This feature helps to ensure that the dead volume, i.e., volume without significant flow, is small. Reactants and products can collect in dead volume, which can lead to chamber contamination, ineffective absorption of light, a low yield, and loss of control of the laser reaction zone.

One approach to achieving this high reactant flux involves the use of a design of main chamber 300 that is elongated along the propagation direction of the light beam. The light beam is directed in a linear path through main chamber 300. For these embodiments, reactant inlet 302 preferably is elongated to correspond roughly to the shape of the elongated main chamber 300. The length of elongated reactant inlet 302 can be evaluated such that sufficient light intensity is available along the length of the reactant stream. The width of reactant inlet 302 can be selected such that the width of the reactant stream roughly corresponds to the width of the light beam. Use of an elongated main chamber for particle production is described further in PCT publication WO 98/37961 to Bi et al., entitled “Efficient Production of Particles by Chemical Reaction,” incorporated herein by reference.

Alternative embodiments of main chamber 300 use a light path which does not follow a single straight line through the reaction chamber. These embodiments may be particularly desirable when the reactant stream is strongly absorbing of light such that having an elongated chamber, as described above, may be problematic. This is useful where the reactant stream is wider than the light beam. For example, a zigzag path through the chamber can be used where the light is bent within main chamber 300 using reflectors or other optical elements. Throughout this application, reflectors include completely or partially reflective mirrors, corner cube reflectors and other reflective optical elements. Alternatively, the light path through the reaction chamber can involve multiple straight line paths that are split outside of the chamber or that originate from multiple light sources.

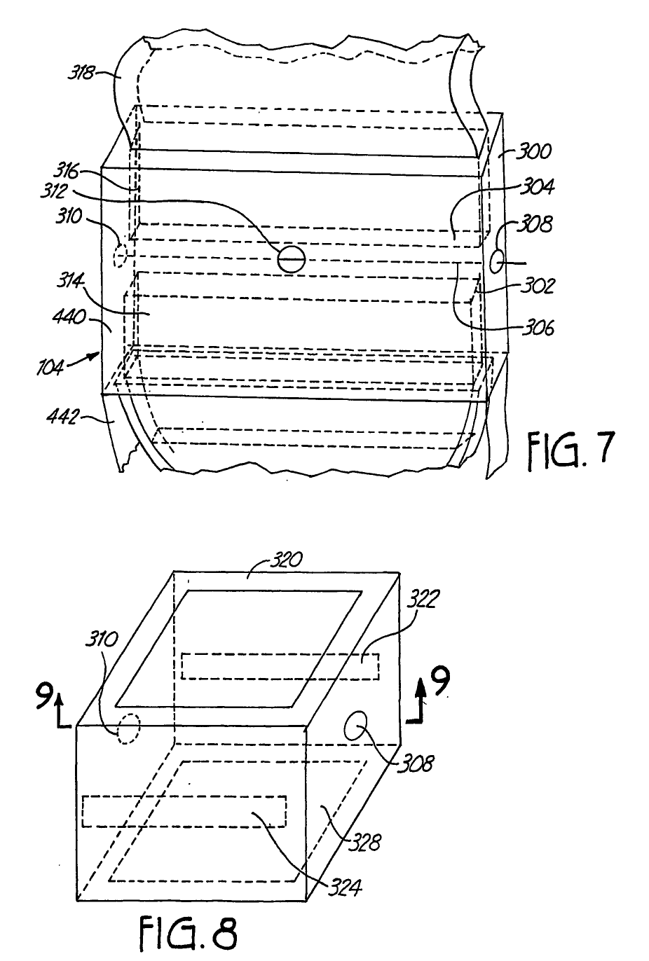

An alternative embodiment 320 of main chamber 300 that achieves a large reactant flux is shown in FIGS. 8 and 9. Main chamber 320 includes two reflectors 322 and 324 that deflect a light beam 326 across the width, “w”, of chamber 320, as shown in FIG. 9. Preferably, due to the width of the beam in the plane of the cross section in FIG. 9, reflected light beam 326 roughly fills a cross section of main chamber 320 except for a portion of the area near the walls holding optical elements 308, 310. The width of the chamber is substantially larger than the width of an incident light beam directed into the chamber.

The angle of light beam 326 entering window 308 and/or the extent of light beam 326 can be adjusted accordingly, to essentially cover the cross section of main chamber 320. Reflectors 322, 324 can be produced from suitable materials to reflect the appropriate type of light radiation. For infrared light, suitable reflectors 322, 324 include mirrors produced from, for example, silicon, molybdenum, copper and/or a thin gold layer. Molybdenum mirrors tend to be the most durable. The reflectors can have cylindrical curvature or symmetry, e.g., cylindrical mirrors, to focus the thickness of the beam along the reactant flow as the beam is reflected back into the reaction chamber. Alternatively, the incident beam can be focused with a very long focal length. Cooling can be supplied to the reflectors to increase their durability. Also, the reflectors can be placed behind a window such that contaminants within the chamber cannot contact the reflector. Contamination of the reflector generally results in the deterioration of the reflector.

An expanded reactant inlet 328 opens into main chamber 320. The width of reactant inlet 328 can extend essentially the entire width of main chamber 320, although smaller widths of reactant inlet 328 can be used to achieve the desired reactant flux and absorption of light. The length of reactant inlet 328 generally corresponds roughly to the coverage of the light beam. Also, the length of reactant inlet 328 and/or main chamber 320 should provide the desired reactant flux, where a desired reactant flux yields a desired production rate and yield.

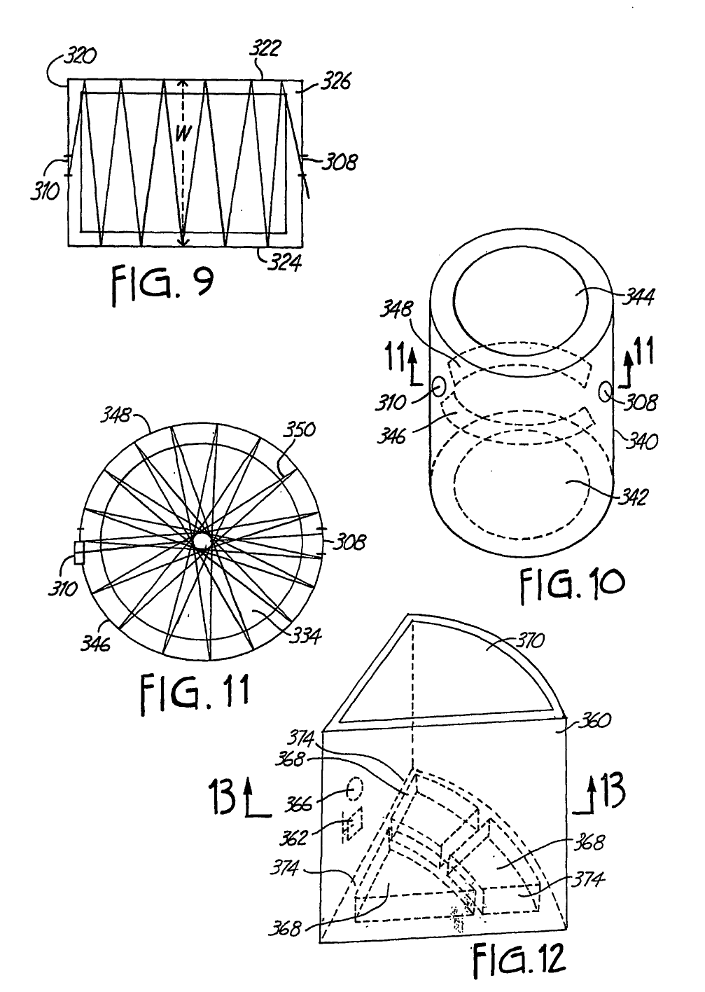

Reactant inlet 328 is depicted in FIG. 8 as being generally rectangular although other shapes, such as circular, elliptical, and the like, can be used. The described shapes refer to the general shapes of the reactant inlet, while the edges and corners can involve slight irregularities, curvatures or oscillations without altering the general shape. The reflectors can be similarly shaped to match the general shape of the reactant inlet. For example, a main reaction chamber 340 with an expanded elliptical, especially round, reactant inlet 342, a corresponding elliptical outlet 344 and curved reflectors 346, 348 is shown schematically in FIGS. 10 and 11. Reflectors 346, 348 direct a light beam 350 that covers a significant portion of the cross section of the circular main chamber 340. Reflectors 346, 348 can be curved in the direction along the flow of reactant to focus the thickness of the beam along the reactant flow as beam is reflected back into the chamber. Additional light beams or light beams with a different orientation can be used to obtain alternative coverage by the light beam or beams.

Another alternative embodiment 360 of main chamber 300 to achieving a large reactant flux is shown in FIGS. 12 and 13. Main chamber 360 has the shape of a pie wedge with two straight sections of chamber wall and a curved section connecting the straight sections. A movable reflector 362 directs a light beam 364 directed through window 366. In the sectional view of FIG. 13, phantom lines indicate the opposite sweep of the reflector and corresponding light beam 364. Main chamber 360 includes appropriately shaped reactant inlets 368 and a reactant outlet 370. The curved wall can include curved reflectors to reflect the light back into the chamber or a light absorber can be used as a beam dump. Preferred reflectors include mirrors formed by thin gold layers. A light absorber preferably is cooled to prevent damage, where cooling can be provided by a water bath or the like.

In operation, the reflector preferably moves or rotates over its range at a relatively rapid rate. In particular, the reflector should scan rapidly relative to the time for the reactants to travel through the reaction zone. Suitably rapid reflector motion can be accomplished with a solenoid, with a piezoelectric transducer attached to the reflector mount or with a rotating motor with a cam. The scan angle, based on chamber design, and the scanning frequency can be selected to obtain desired coverage of the chamber with the laser beam. Preferably, a high scan frequency is used to obtain better coverage of the chamber. Suitable reflector materials are described above. Generally, for high intensity light, the reflector should be cooled. Window 308 provides for a light beam that strikes the reflector at a suitable angle to reflect the light over the desired range.

With any of the possible embodiments having a high reactant flux and an extended reaction chamber, a plurality of reactant nozzles can be used to supply desired reactants at desired reactant fluxes. For example, three reactant nozzles 374 are depicted in phantom lines in FIG. 12, leading to three reactant inlets 368. Alternatively, two, four or more nozzles can be used. Reactant inlets 368 overall cover the desired cross section of reactant chamber 360.

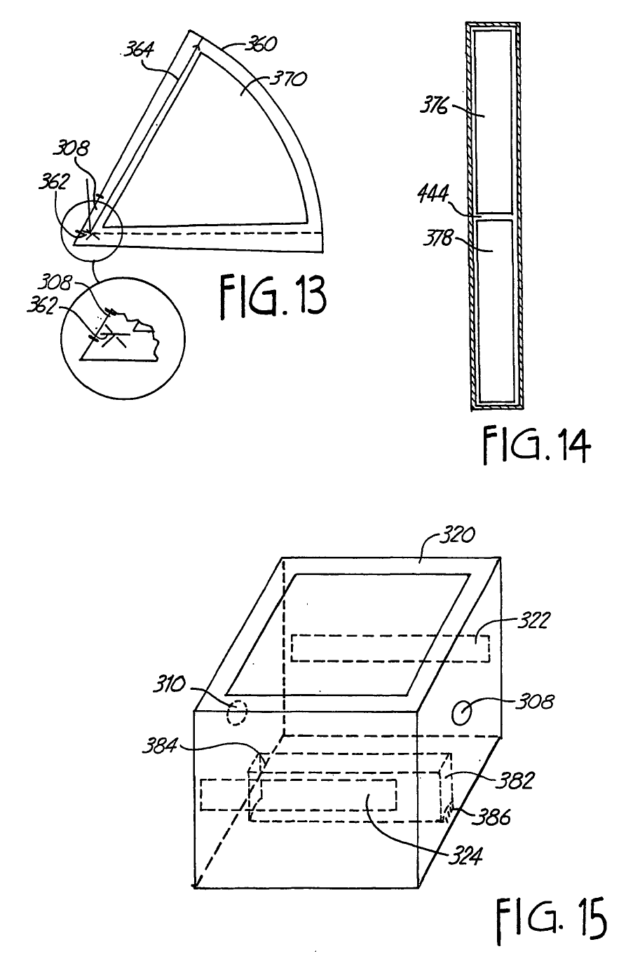

Different reactants can be directed to one or more nozzles 374 of the reaction chamber of FIG. 12. If inlets 368 are configured for little, if any, mixing of the reactants from the different inlets, two or three distinct reactions yielding distinct products can be exploited. Mixing can be reduced or eliminated by supplying shielding gas between the flow from the different inlets. The reaction products can be combined within the collection system to form a desired blend. Similarly, a two inlet configuration for the elongated reaction chamber design of FIG. 7 is shown in FIG. 14. A first inlet 376 is located adjacent to a second inlet 378.

To take advantage of an extended reaction chamber to produce a high reactant flux, a reactant nozzle can be used that pivots. Thus, a reactant nozzle having a reactant inlet can move to fill the selected portion of the reaction chamber with reactant. A higher reactant velocity can be obtained using a smaller reactant inlet without needing to raise the pressure in other parts of the reactant delivery apparatus to correspondingly higher values. For example, in FIG. 15 a pivoting nozzle 382 has been adapted for use with the reaction chamber depicted in FIG. 8. A reactant inlet 384 is located at the end of pivoting reactant nozzle 382. Pivoting nozzle 382 pivots around pivot 386. Pivoting nozzles can be similarly adapted for other chamber shapes that are extended in one or two dimensions.

The flight time of the reactant stream through the light beam can affect the properties of the product particles formed by laser pyrolysis. The flight time can be altered by changing the flow rate through the reaction chamber. Alternatively, the flight time can be altered by changing the light beam thickness, as described further below. Also, the flight time of the reactants through the light beam can be extended by changing the angle of the reactant stream relative to the propagation direction of the light beam.

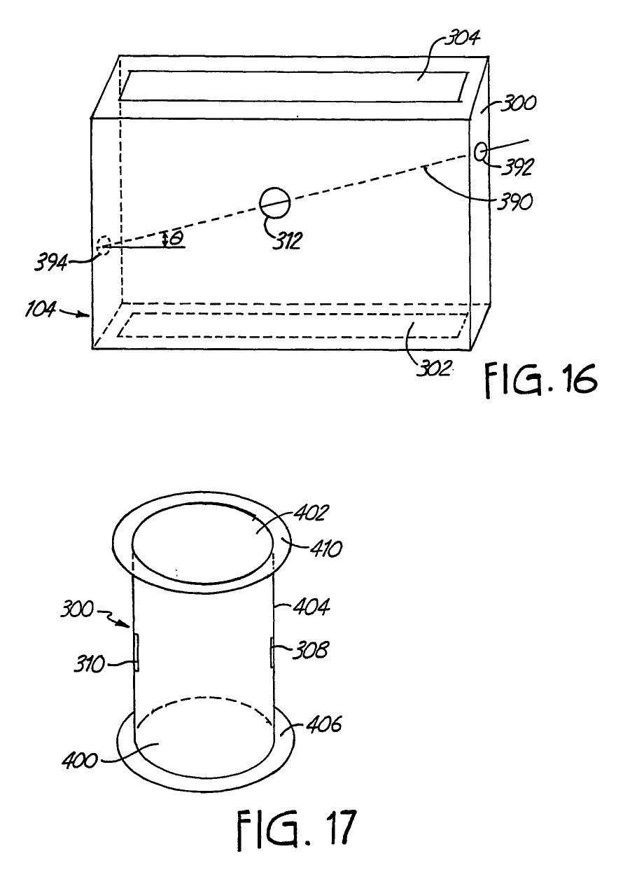

Referring to FIG. 16, slanted light beam 390 enters main chamber 300 through displaced window 392 and strikes displaced optical element 394. The flight time is extended roughly by 1/cos Θ, as long as Θ is not close to π/2. In the limit that the light beam is approximately oriented along the reactant path, the flight time reaches a limiting value determined by the path length over which the light beam and the reactant flow overlap before they are deflected away from each other. To obtain a desired angle between the light beam and the reactant stream, the reaction chamber, the light beam or both can be tilted relative to each other.

While reactant inlet 302 can be associated with a reactant nozzle projecting into main chamber 300, the nozzle can be eliminated such that the reactant inlet is flush with the corresponding wall of main chamber 300. Similarly, a reactant inlet 400 can span the entire bottom of main chamber 300, as shown in FIG. 17, with reactant inlet 400 attached to reactant delivery system 102 at flange 406. Reactant inlet 400 and outlet 402 are located at the ends of pipe shaped main chamber 404. Outlet 402 connects with collection apparatus 106 at flange 410. Although depicted in FIG. 17 as circular, main chamber 404 can have other cross sectional shapes, such as rectangular, square and elliptical, as desired. The optical path can be selected according to the shape of main chamber 404.

Main chamber 404 has the advantage of ease of construction since the main chamber does not have to be matched with a nozzle. To some extent, the precise boundaries of this embodiment of reaction chamber 300 holding the reaction zone are arbitrary. At some point, though, the collection system and reactant delivery system will have functional components that clearly delimit the reactant delivery system and the collection system from any possible boundary for the reaction chamber.

4. Contamination Prevention

In any of the embodiments, reactants and product particles can contaminate chamber walls and optical elements. Also, contaminants in the reaction chamber can contaminate later products such that the later products lack desired levels of uniformity. Referring to FIG. 7, to reduce the spread of reactants and products from the reactant/product stream flowing from reactant inlet 302 to outlet 304, reaction chamber 104 preferably includes a shielding gas supply system. In preferred embodiments, shielding gas forms a blanket around the reactant stream within reaction chamber 104. The shielding gas preferably is an inert gas, although a reactant, such as oxygen, can be included with the inert gas such that a portion of the reactant can mix with the remaining portion of the reactant stream. Suitable inert gases may depend on the specific reaction being performed in the reaction chamber 104. Generally, suitable inert gases include, for example, argon, helium, and nitrogen.

In FIG. 7, a shielding gas inlet 440 is located between nozzle 314 and the wall of main chamber 300. In this way, shielding gas is delivered on all sides of the reactant stream. Shielding gas channel 442 feeds into shielding gas inlet 440. Shielding gas channel 442 connects with a shielding gas source that can be a pressurized gas cylinder, a liquified gas supply or the like. A variety of alternative configurations can be used for the shielding gas inlet, as desired. For example, a configuration of a shielding gas inlet 444 for a two inlet elongated chamber design is depicted in FIG. 14. Shielding gas is directed between reactant inlets 376, 378 such that independent reactions can be performed. Alternatively, no shielding gas can be directed between inlets 376, 378 if equivalent reactants are directed through each inlet. Furthermore, the shielding gas inlet can be configured for different shapes of main chamber 300 and the corresponding inlet 302, such as those shown in FIGS. 8-13 and 17.

In alternative embodiments, shielding gas is delivered through small openings or pores in the chamber walls. Preferably, the volume of shielding gas is kept low to reduce cost. For example, approaches used for cooling the walls of turbine combustors, such as thin film cooling techniques, can be adapted for the delivery of shielding gas. The idea is to deliver a thin film of shielding gas along the walls of the reaction chamber.

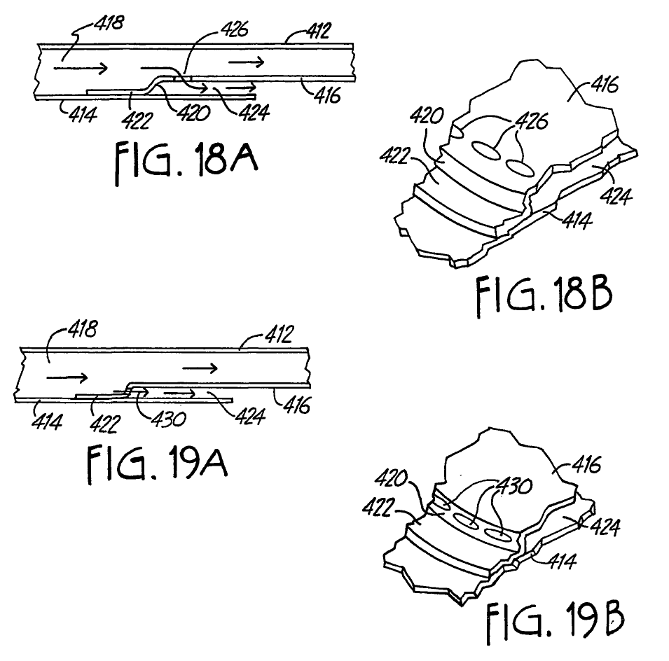

Referring to FIGS. 18A and 18B, a first approach for thin film shielding gas delivery is depicted. The chamber walls include an outer wall 412. The inner chamber wall includes two or more overlapping sections, including first section 414 and second section 416, which extend around the circumference of the reaction chamber to form the inner wall of the reaction chamber. First section 414 has a smaller diameter around the circumference of the reaction chamber compared with second section 416 such that they can overlap as shown in FIGS. 18 and 19. A delivery channel 418 is located between outer wall 412 and inner walls 414, 416. Delivery channel 418 is connected to a source of inert shielding gas. Inner wall 416 includes a bend 420 to connect to flange 422 that is welded or otherwise secured against inner wall 414. The overlapping region between inner walls 414, 416 forms a channel 424 that directs a thin film of shielding gas along inner wall 416. Shielding gas passes into channel 424 through openings 426.

An alternative embodiment of a thin film system is shown in FIGS. 19A and 19B. In this embodiment, openings 430 are located along bend 420 such that shielding gas impinges on inner wall 414 to distribute flow within channel 424 so that flow is more or less uniform as it exits channel 424 along inner wall 416. While the flow arrows in FIGS. 18A and 19A indicate an overall flow within delivery channel 418 from left-to-right, the flow within delivery channel 418 can be in the opposite direction from right-to-left. The pressure in delivery channel 418 is higher than the pressure in the reaction chamber such that inert gas flows into channel 424. If a plurality of film delivery channels 424 are used, as described below, the flow arrows within delivery channel 418 can have different relative directions for different sets of channels 424 combination if the inlet of shielding gas is between two sets of openings 426 or 430.

In FIGS. 18-19 only one film directing channel 424 extending the circumference of the reaction chamber is shown. Additional film directing channels can be formed along the direction of flow within the reaction chamber using additional sections of inner wall, if desired for the efficient delivery of shielding gas. These series of channels 424, each extending around the circumference of the reaction chamber, preferably are repeated along the length of the chamber to the collector. In preferred embodiments, flow from the reaction chamber is directed to the collector along the inner walls of the reaction chamber form a part of an outlet into the collection system without a distinct channel 316 constricting the flow from the reaction chamber to conduit 318, as shown in FIG. 7. If the inner walls of the chamber smoothly connect to conduit 318, the series of channel 424 can continue into conduit 318 until the processing part of the collector is reached.

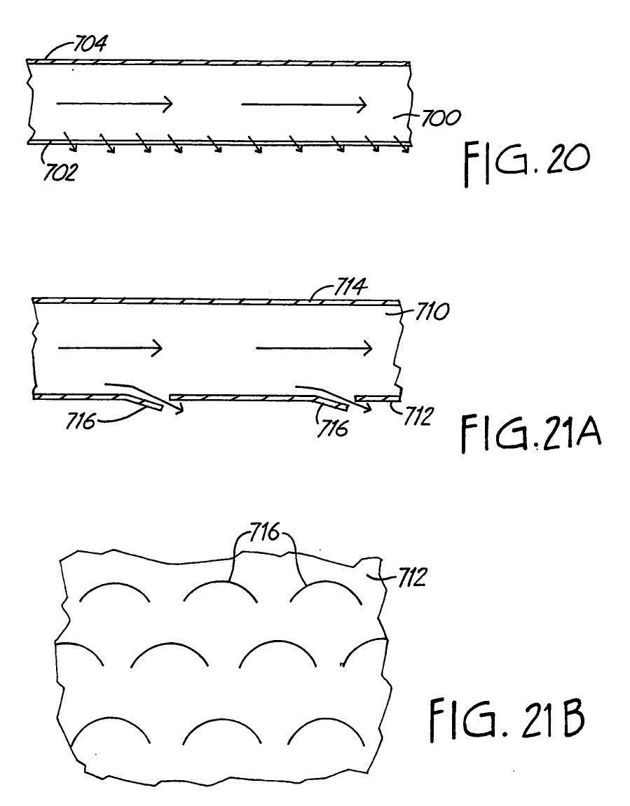

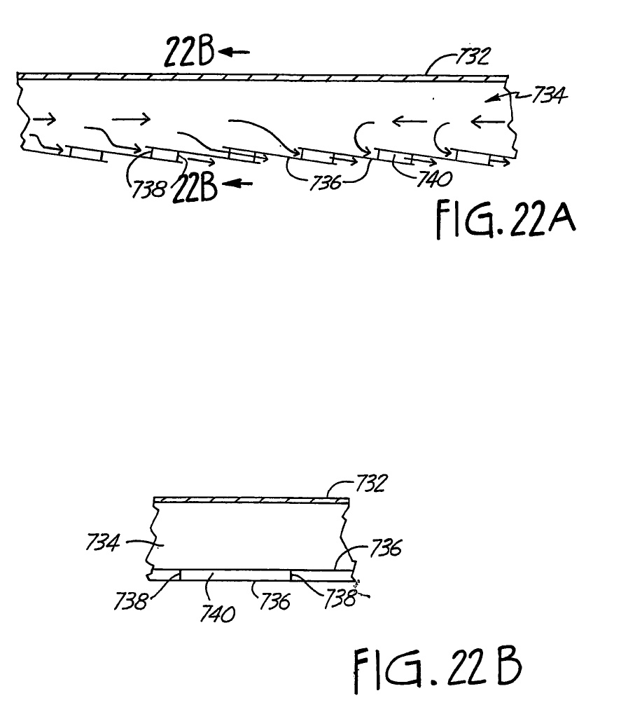

In another alternative embodiment, the chamber walls along the direction of the reactant flow include an inert gas channel 700 between an inner wall 702 and an outer wall 704, as shown in FIG. 20. All or a portion of inner wall 702 is a porous metal such that inert gas permeates into the interior of the reaction chamber. Thus, a film of inert gas lines the porous metal along the wall of the reaction chamber.

In a similar embodiment, the chamber walls include an inert gas channel 710 between an inner wall 712 and an outer wall 714, as shown in FIGS. 21A and 21B. Inner wall 712 is formed from stamped metal that has louvers 716 along inner wall 712 that form openings through inner wall 712. Some inert gas flowing within channel 710 flows through louvers 716 into the reaction chamber along inner wall 712. Additional variations on the this approach can be used to deliver a thin film of shielding gas along the inner wall of the reaction chamber.

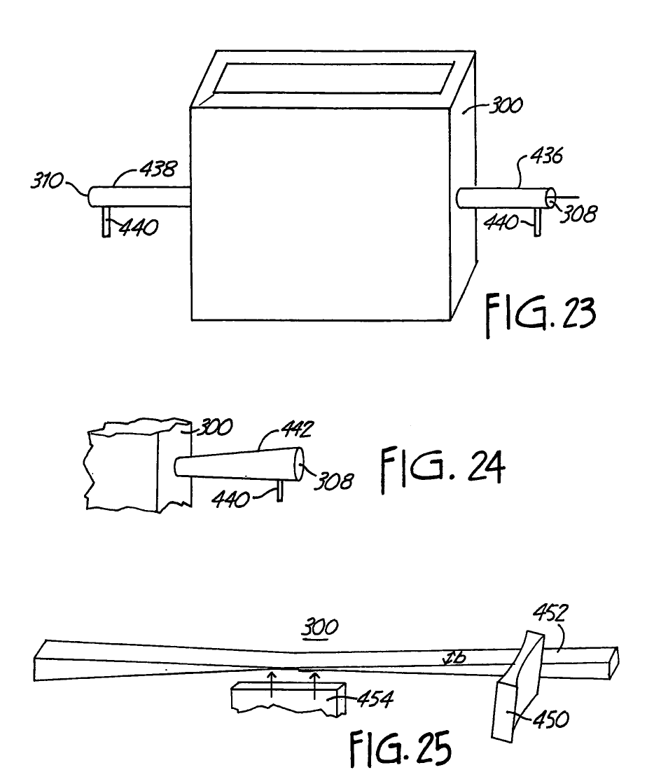

A further alternative embodiment is shown in FIGS. 22A and 22B. The shielding gas delivery conduit 730 is formed by outer wall 732 and inner wall 734. Inner wall 734 is formed by a series of wall sections 736. Each wall section 736 extends around the circumference of the reaction chamber. Wall sections are secured to adjacent sections by spacers 738 to form the inner wall. Shielding gas delivery channels 740 are formed between wall sections 736. The dimensions of wall sections 736 and spacers 738 are selected to yield desired dimensions for channels 740.

While window 308 and optical element 310 are shown in FIG. 7 along the wall of main chamber 300, window 308 and optical element 310 are displaced away from the wall of main chamber 300, in some preferred embodiments. Referring to FIG. 23, tubes 436, 438 displace, respectively, window 308 and optical element 310 from main chamber 300. Window 308 and optical element 310 are located, respectively, near the end of tubes 436, 438 away from the reactant stream.

Tubes 436, 438 preferably are relatively long and narrow to prevent significant amounts of displaced reactant gases or product particles from flowing to the end of tubes 436, 438. Preferably, tubes 436, 438 have an inner diameter no more than about twice the diameter of the radiation beam. Generally, appropriate lengths for the tubes depend on the tube diameter. Tubes 436, 438 extend preferably between 1 diameter and 100 diameters from main chamber 300, and more preferably between about 1 diameter and about 20 diameters. The desired length of tubes 436, 438 may be affected by the focus of the light beam. The dimensions of tube 438 may or may not be the same as the dimensions of 436, depending on the focus of the beam and other design considerations. Tubes 436, 438 generally can be made from the same material or materials as main chamber 300. Tubes 436, 438 preferably include an inlet 440 for inert gas to purge tubes 436 and 438 to reduce contamination from reaction chamber 300.

Alternatively, especially if optical element 310 is a beam dump, optical element 310 can be placed flush with the chamber wall without use of a tube 438. Beam dumps are designed to absorb the energy from the radiation. Thus, a beam dump is not as sensitive to contamination by reactants or products within chamber 300. In another alternative embodiment, both window 308 and optical element 310 are placed on the reactor wall with little or no displacement away from the reactor wall. In this configuration, sufficient shielding gas should be used to prevent contamination of window 308 and/or optical element 310.

It may be advantageous to use a tapered tube 442, as shown in FIG. 24. With this configuration, the opening between tube 442 and reaction chamber 300 is smaller than window 308. The taper of tube 442 results in higher inert gas velocity at the opening of tube 442 into main chamber 300 for a given inert gas pressure in inlet 440. If the light directed through the tube into the chamber is focused, the shape of the tube can account for the changing diameter of the light beam. Optical component 310 may or may not be mounted on a corresponding tapered tube, depending on the nature of the beam focus, the nature of optical component, and other design considerations.

Window 308 and optical element 310 can be mounted onto main chamber 300 or onto tubes 436, 438, respectively, with a vacuum o-ring seal or by fusing the lens directly into the stainless steel flanges. Alternatively, the radiation source can be located within tubular member 436.

5. Optics and Light Beam Control

Window 308 provides for the entrance of the light beam into reaction chamber 104, while reaction chamber 104 is sealed from the ambient atmosphere. Window 308 can be a planar window that transmits a significant amount of the incident light radiation over a desired frequency range. Alternatively, window 308 can be a lens that focuses the transmitted light. Furthermore, window 308 can be a component of the light source, such as the partly reflective output coupler or mirror of a laser.

Referring to FIG. 25, in certain preferred embodiments, window 308 is a cylindrical lens 450 that focuses the thickness of light beam 452 roughly in the center of main chamber 300 without changing the width of light beam 452. The width “b” of light beam 452 is oriented perpendicular to the propagation direction of reactant stream 454. Using a cylindrical lens has the disadvantage that the flight time of reactant stream 454 through light beam 452 generally is different at different points with different thicknesses along light beam 452. This variation in the thicknesses due to focusing with a cylindrical lens can be reduced by changing the depth of field and by introducing spherical aberrations. However, a cylindrical lens can produce a narrow light beam within the reaction zone. Alternatively, window 308 can be a piano, i.e. flat, window, and a cylindrical lens can be placed at another point between the light source and the reaction zone, where the light beam intersects the reactant stream.

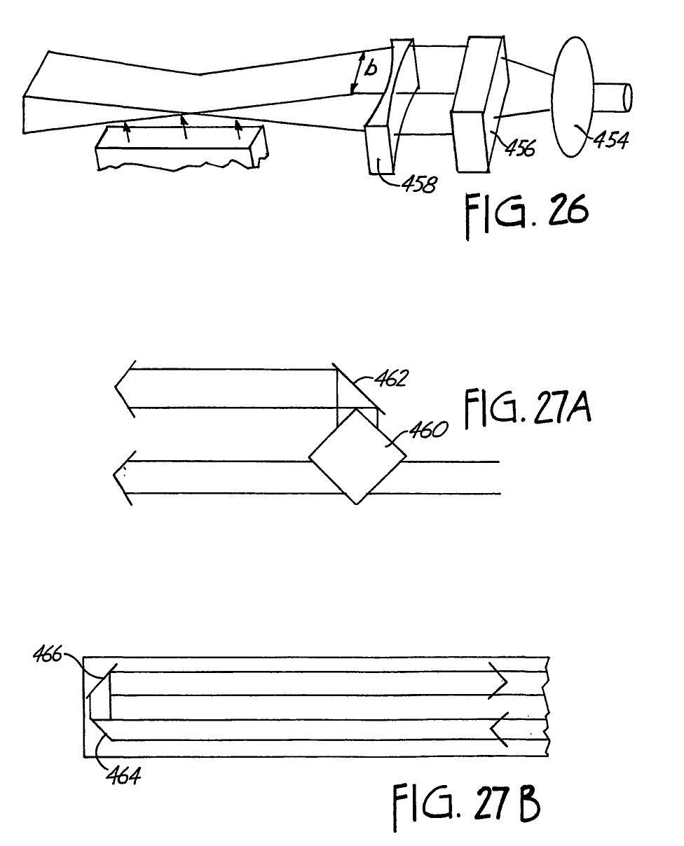

In an alternative embodiment, as depicted in FIG. 26, the beam is first expanded with a spherical lens 454 and collimated with collimating optics 456 prior to a cylindrical lens 458. Expansion and collimation of the beam provides a wider width “w” to accommodate a wider reaction chamber and reactant inlet or inlets with a correspondingly larger reactant flux.

An alternative way of accommodating a wider reaction chamber/reactant inlet involves the use of a beam splitter. Referring to FIG. 27A, a beam splitter 460 splits the incident beam into two components. A reflector 462 is used to direct the second beam, as desired. Generally, the second beam is directed parallel to the transmitted first beam to provide an effective wider beam through the reaction chamber. The second beam can be directed to a second reaction chamber. Focusing optics can be placed as desired along one or both beams.

As an alternative to using a beam splitter, two reflectors 464, 466 can be used to reflect the beam parallel to the incident beam in the opposite direction but displaced slightly from the incident beam, as shown in FIG. 27B. For example, the first reflector 464 can be placed at 45 degrees relative to the incident beam with the second reflector 466 being at 90 degrees relative to the first reflector. Reflectors 464, 466 may or may be curved reflectors, which focus the beam. For example, reflector 466 can be a cylindrical mirror that focuses the thickness of the beam at the center of the reaction chamber. Thus, the reflected beam effectively widens the reaction zone. Other optical elements can be included along with the two reflectors. The reflected beam can be directed to a beam dump or further optics to redirect the beam. Using either a beam splitter or a displaced reflected beam, the two approximately parallel beams may or may not overlap.

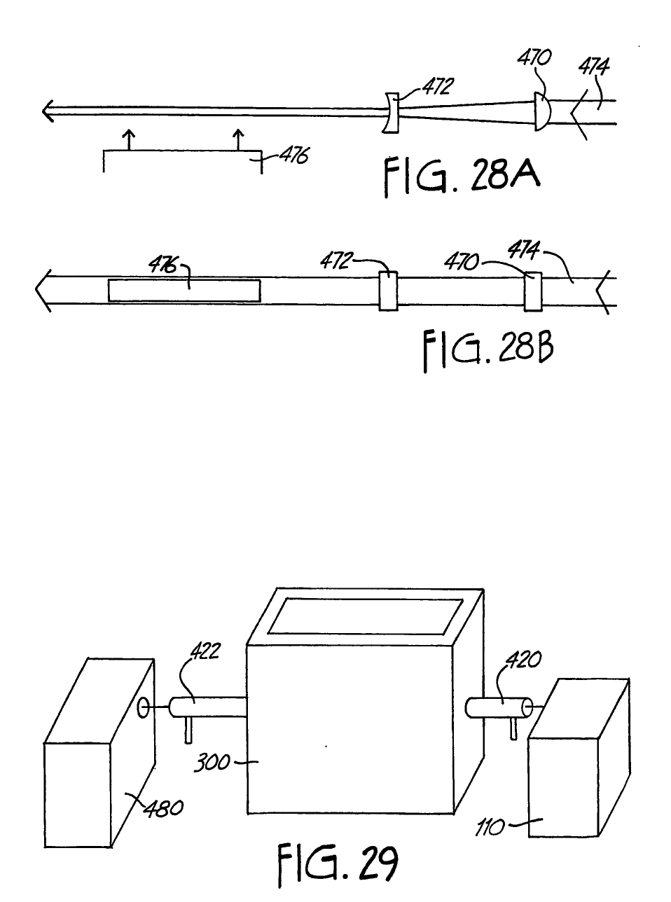

In an alternative preferred embodiment, collimating optics are used to compress (or expand) the beam thickness. For example, suitable collimating optics can comprise telescope optics, as shown in FIGS. 28A and 28B. In FIGS. 28A and 28B, two cylindrical lenses 470, 472 are used to narrow the thickness of light beam 474 along the direction of propagation of reactant stream 476. Cylindrical lens 470 is a positive (focusing) cylindrical lens. Cylindrical lens 472 is a negative (defocusing) lens placed a distance from cylindrical lens 470 of less than one focal length of cylindrical lens 470. The focal lengths of cylindrical lenses 470, 472 and the distance between cylindrical lenses 470, 472 can be determined based on the desired thickness of light beam 474 in the reaction zone using standard optics principles.

Additional lenses can be used to control aberrations, diffraction based spreading of the beam, focusing, and other optical properties of the beam for the embodiment in FIGS. 28A and 28B. Referring to FIG. 7, either lens 470, 472 can serve as window 308, although generally as many of the optical elements are placed outside of reaction chamber 104 as possible to reduce contamination of the optical elements. Both lenses 470, 472 can be placed inside or outside of reaction chamber 104, and window 308 can be a planar, nonfocusing window.

The optical configuration in FIGS. 28A and 28B can be used to obtain a more uniform light beam across the reaction zone. In particular, the light beam in the reaction zone preferably has a maximum thickness in the direction along the reactant flow no more than a factor of ten greater than the minimum thickness, more preferably no more than a factor of five and even more preferably no more than a factor of two greater than the minimum thickness. Since the time of flight of the reactants through the light beam generally is more uniform with telescopic optics as shown in FIGS. 28A and 28B, the product particles may have correspondingly more uniform properties. In particular, the use of telescopic optics to adjust the beam may result in a narrower distribution of particle sizes, depending on the precise reaction conditions. Thus, the optical configurations in FIGS. 28A and 28B can be used to obtain extremely uniform product particles that have an even higher degree of uniformity than the highly uniform particle generally produced by laser pyrolysis. Furthermore, optical elements 470, 472 can be selected or adjusted to produce a desired average particle size.

In the chamber configurations shown in FIG. 7 and FIG. 23, optical element 310 can be, for example, a window, reflector or a beam dump. If optical element 310 is a beam dump, the light beam striking the beam dump is absorbed. Preferred beam dumps provide measurements of beam intensity, i.e., beam dumps preferably function as light power meters. Measurements of beam intensity from a light meter can be used to monitor reaction parameters. If optical element 310 is a window, the light beam exits main chamber 300 at optical element 310.

If optical element 310 is a reflector, the light beam is reflected back into reaction chamber 104. For an elongated main chamber as shown in FIG. 7, the reflector can reflect the beam directly back into the incident direction to fold the light beam. This reflection back of the light beam can help to compensate for dissipation of the light beam due to reaction. For low total dissipation due to reactant stream absorption such that light absorption is linear, folding the beam results in a constant light energy density through the reaction zone since the reflected beam itself is dissipated as it projects toward entrance window 308. With higher absorption, the light energy density generally is not constant, but it is more uniform with the optical element being a reflector than would be obtained without folding the light beam. A partly reflective mirror can be used to direct the light beam into the chamber, such that a portion of the incident beam is directed to a power meter, which is used to monitor and adjust the stability of the incident light beam.

If the light source is a laser, reflecting the beam directly back along the incident direction should not damage the laser optics as long as the beam does not spread significantly. Care should be taken to avoid harming the laser if the reflected beam has significant power and the beam has spread significantly. Alternatively, the reflector can reflect the beam at a slight angle, such that the beam does not reflect directly back into the laser. A curved mirror preferably is used as the reflector to focus the reflected beam at or near the center of the reaction zone. The reflector can direct the light beam in alternative directions, which may be preferable for certain shapes of reaction chamber 104.

Alternatively, optical element 310 can be a window that may or may not focus the light beam. If optical element 310 is a window, optical element 310 can direct the light beam to a beam dump/light meter, to a second reaction chamber, or to a second light source. Additional intervening optics can be used. The use of multiple reaction chambers with a single light beam is discussed further in published PCT Patent Application WO 98/37961 to Bi et al., entitled “Efficient Production of Particles by Chemical Reaction,” incorporated herein by reference.

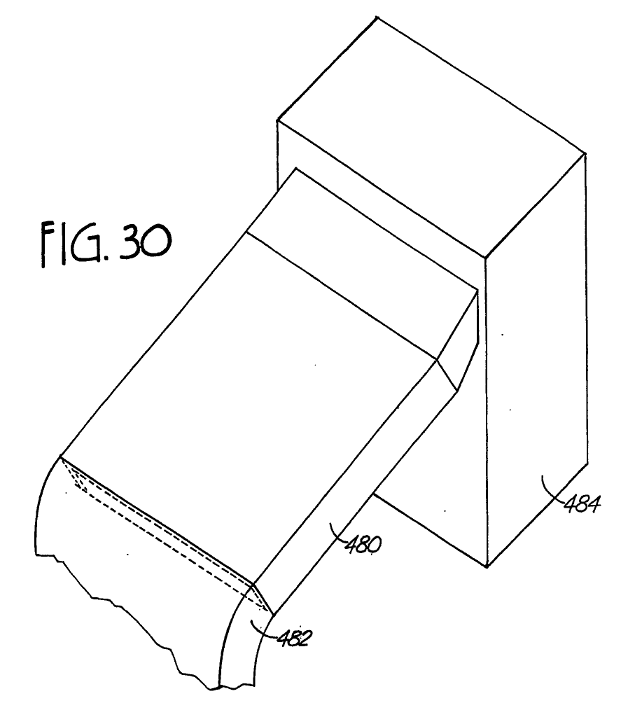

As noted above, optical element 310 can be a window oriented toward a second light source 480, as shown in FIG. 29. Preferably, the beams from light sources 110, 480 are aligned with each other. If light sources 110, 480 are lasers, the laser optics should not be damaged if two beams are collinearly aligned, assuming that the beams do not spread significantly. If light sources 110, 480 are roughly equivalent with respect to frequency and intensity, the use of two light sources 110, 480 leads to a more uniform light intensity within the reaction zone. Multiple reaction chambers can be located between light source 110 and light source 480. Alternatively, light sources 110 and 480 can be displaced in the horizontal or vertical directions.

Light sources 110, 480 can be lasers or conventional light sources. Similarly, light sources 110, 480 can be monochromatic or polychromatic. Light sources 110, 480 can produce light in any portion of the optical spectrum ranging from infrared frequencies to ultraviolet frequencies. Over this frequency range, the light is optical radiation that can be manipulated using conventional optical elements such as reflectors and lenses. Preferred embodiments for light sources 110, 480 include infrared lasers, such as CO₂ lasers and YAG lasers, and ultraviolet lasers, such as eximer lasers and pumped dye lasers tuned to photodissociate one or more reactants. With ultraviolet light, the windows into and out from the reaction chamber can be made from quartz. Ultraviolet light with appropriately selected frequencies can be used to drive various reactions that may or may not be of a pyrolytic nature. For example, ultraviolet light can be used to form oxygen radicals from molecular oxygen. Oxygen radicals are a powerful oxidizing agent. In addition, ultraviolet light can drive the polymerization of organic compounds.

6. Collection System

Referring to FIG. 1, collection system 106 preferably is located at the top of reaction system 100 for the collection of nanoparticles since nanoparticles generally are buoyant in the reactant/product stream. Alternatively, collection system 106 and reactant delivery system 102 can be reversed such that product is collected from the bottom of reactant system 100 and reactants are delivered from the top, where the flow helps to compensate for possible buoyancy of the particles. Similarly, the entire apparatus can be rotated about 90° such that the reactant stream is projected horizontally. A horizontal orientation can be helpful for very high throughputs.

In addition, it may be desirable to orient the reaction chamber at an angle relative to the vertical arrangement shown in FIG. 7. In one preferred embodiment, reaction chamber 480 is placed at an angle, as shown in FIG. 30. Reaction chamber 480 is connected to a reactant delivery apparatus 482 and a particle collection apparatus 484. Since reaction chamber 480 is at an angle, a curved channel is not needed between reaction chamber 480 and particle collector 484. Removal of the curved channel may improve the flow properties through the system.

Reactant system 100 can be designed for operation in a batch mode or a continuous mode. In a batch mode, the reaction must be terminated or suspended in order to harvest the product particles. In continuous mode, product particles can be harvested while particle production and collection continues. For example, continuous particle collection can be accomplished by diverting flow from one batch type collector to a second batch type collector, such that the first collector can be replaced while the second is used to collect product particles. A variety of collection system configurations can be used for either batch or continuous operation.

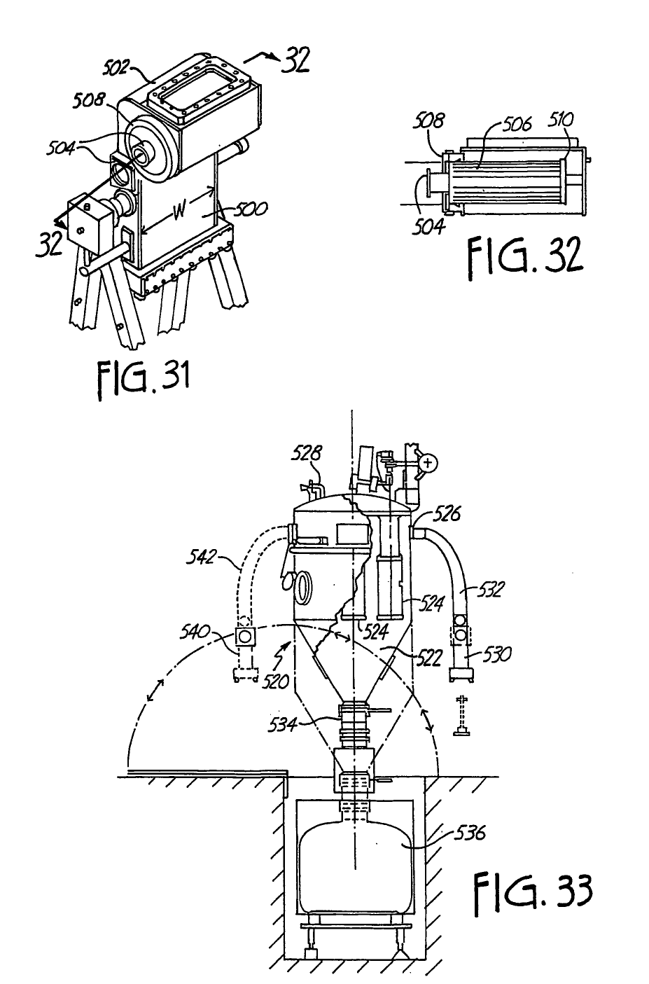

For batch operation, a convenient configuration of the collection system includes a filter in the flow that traps a substantial amount of the product particles. An embodiment of a collection system 500 with an elongated reaction chamber and a batch collection system is depicted in FIGS. 31 and 32. The outlet of reaction chamber 500 leads at its top to a curved channel 502. Preferred collection systems include a curved channel, especially when the collection system is mounted at the top of the reaction chamber such that the particles are not collected directly above the reaction chamber.

In the embodiment shown in FIGS. 31 and 32, a cylindrical filter 506 is located in the flow path between reaction chamber 500 and exhaust 504. Cylindrical filter 506 is mounted at seal 508. Cap 510 is located at the end of cylindrical filter 506. Exhaust 504 generally is connected to a pump or the like to maintain the pressure within reaction chamber 500 at a desired pressure. The collection of manganese oxide nanoparticles using a reaction chamber and collection system essentially as depicted in FIGS. 31 and 32 is described in copending and commonly assigned U.S. patent application Ser. No. 09/188,770, now U.S. Pat. No. 6,506,493 to Kumar et al., entitled “Metal Oxide Particles, incorporated herein by reference.

A collection apparatus 520 for continuous particle collection is depicted in FIG. 33. Collection apparatus 520 includes a tank 522 and a plurality of filters 524. Filters 524 block flow paths from inlet 526 to exhaust 528. Exhaust 528 generally is attached to a pump or the like to maintain the pressure with tank 522 at desired values. Reaction chamber 530 is attached to a channel 532 that connects to inlet 526. A burst of air or a mechanical vibration is delivered to filters 524 to dislodge particles. Dislodged particles fall through valve 534 for collection in a container 536. Valve 534 can be closed to allow replacement or emptying of container 536, when it is full. A second reaction chamber 540 can be attached to collection apparatus 520 by way of channel 542. The improved collection apparatus shown in FIG. 33 is described further in copending and commonly assigned U.S. patent application Ser. No. 09/107,729, now U.S. Pat. No. 6,270,732 to Gardner et al., entitled “Particle Collection Apparatus and Associated Methods,” incorporated herein by reference.

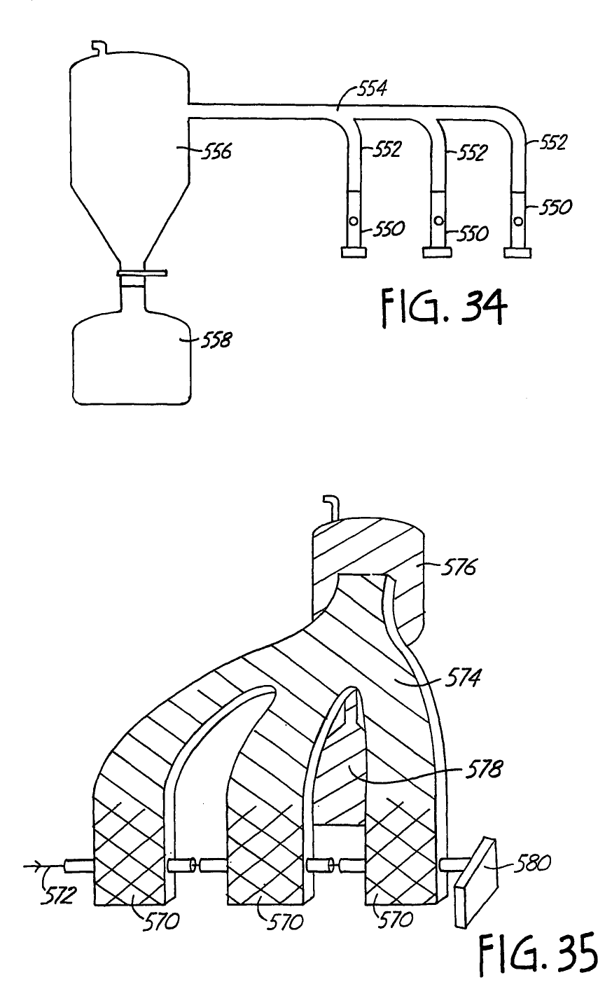

To produce different product particles, a plurality of reaction chambers 550 can be connected in parallel, as shown in FIG. 34. The number of reaction chambers can be two, three, four or more, as desired. The particles produced in different reaction chambers 550 may or may not differ in composition and/or particle properties, such as size, as desired. For certain applications it may be desirable to have mixtures of particle collections in which each collection is highly uniform. The chambers have curved channels 552 that feed into a manifold 554. Manifold 554 leads to a particle collection system 556. The different particles mix in manifold 554 and mix further in collection system 556 such that a particle mixture is collected in container 558.

As noted above, a light beam can be directed sequentially through a series of reaction chambers. The product of each reaction chamber can be separately collected for use. In an embodiment shown in FIG. 35, a plurality of reaction chambers 570 is arranged such that a single light beam path 572 extends through multiple reaction chambers 570. The chambers can be in a line or in an alternative relationship with appropriate optics to direct the light beam from chamber to chamber. The number of reaction chambers can be selected as desired if sufficient light intensity is available. This embodiment can be particularly useful if subsequent reactions require a lower light intensity than reactions in chambers placed at prior positions along the light beam. Thus, light beam 572 that is attenuated by passage through one reaction chamber 570 subsequently passes through another reaction chamber 570 such that efficient use is made of light beam 572. Reaction chambers 570 lead to a manifold 574 for the mixture of the product particles and for the direction of the particles into particle collector 576. The mixture of product particles is collected in container 578. Light beam 572 can terminate at beam dump 580.

7. Control of the Reaction System

Referring to FIG. 1, controller 112 preferably includes a computer processor. The computer processor preferably is incorporated into a personal computer although various work stations, main frame computers or custom designed dedicated processors can be used. The computer processor can use a Windows®, Macintosh®, UNIX®, or other reasonable operating system. The computer can run commercial control system software appropriately programmed to operate the particular system. Suitable control software includes LABVIEW®. Controller 112 preferably is connected by suitable parallel or serial connections 590 to reactant delivery system 102, reaction chamber 104, collection apparatus 106, and/or laser 110.

With respect to control of the reaction system, the various system parameters can be controlled to achieve very uniform reaction conditions. During the formation of commercial quantities of particles, the reaction system may be operated for extended period of time over which there is additional opportunity for reaction parameters to vary. Therefore, the development of improved approaches to control reaction conditions can be used to maintain product uniformity over an extended production run.

In addition, by further improving the uniformity of the reaction conditions, it is possible to form more highly uniform product particles. As noted above, one approach to obtaining more highly uniform particles involves the use of optics that produce a laser beam path within the reaction chamber that has a more uniform thickness through the reaction zone. Thus, improved control approaches can be used to maintain the uniformity of the reaction conditions over extended periods of time, as well as improving the uniformity of the reaction conditions within the reaction chamber to produce a more uniform product than could be achievable before. A second goal is to use information regarding the reaction to assist with the selection of suitable reaction conditions to produce desired product particles.

A variety of reaction parameters influences the characteristics of product particles produced in a laser pyrolysis chamber. The chamber pressure can be varied with a valve leading from the reaction chamber to a pump. Generally, a pump or fan is needed regardless of the desired value of the reaction pressure since the flux of material must be maintained through the chamber, although the back pressure of the reactants and shielding gases can, in principle, maintain a desired flux.

The pressure in the reaction chamber generally is measured with a pressure gauge. For example, a manometer can be used as a pressure gauge. Manometers provide accurate linear responses with respect to pressure. In preferred embodiments, the pressure gauge is connected to controller 112. Controller 112 can be used to monitor the pressure in reaction chamber 104 and maintain the pressure in reaction chamber 104 within a specified range using a feedback loop with the collection system. The operation of the feedback loop depends on the structural design of the collection system, and may involve, for example, the adjustment of a valve, pump speed and/or filter pulsing rates.

Referring to FIG. 1, collection system 106 generally includes a pump 590 and a valve 592 leading to the pump. Controller 112 can adjust the opening of the valve or the pumping rate, as part of a feedback loop with the chamber pressure. Suitable automatic valves for interfacing with controller 112 are available from Edwards Vacuum Products, Wilmington, Mass. If manual values are used, controller 112 can notify an operator to adjust the manual valve appropriately.

Similarly, controller 112 can adjust other parameters within collection apparatus 106. For example, if collection apparatus 106 includes multiple collection ports, controller 112 can switch between two ports when a filter or other collection vessel accessed through one port is so full of product that pressure cannot be maintained. Alternatively, with the collection apparatus shown in FIG. 33, the pulse parameters for pulsing the filters can be altered to improve the pressure consistency in the reaction chamber. The pressure differential across the filter can also be monitored. Similarly, other parameters of the collection apparatus can be adjusted by controller 112, as appropriate.

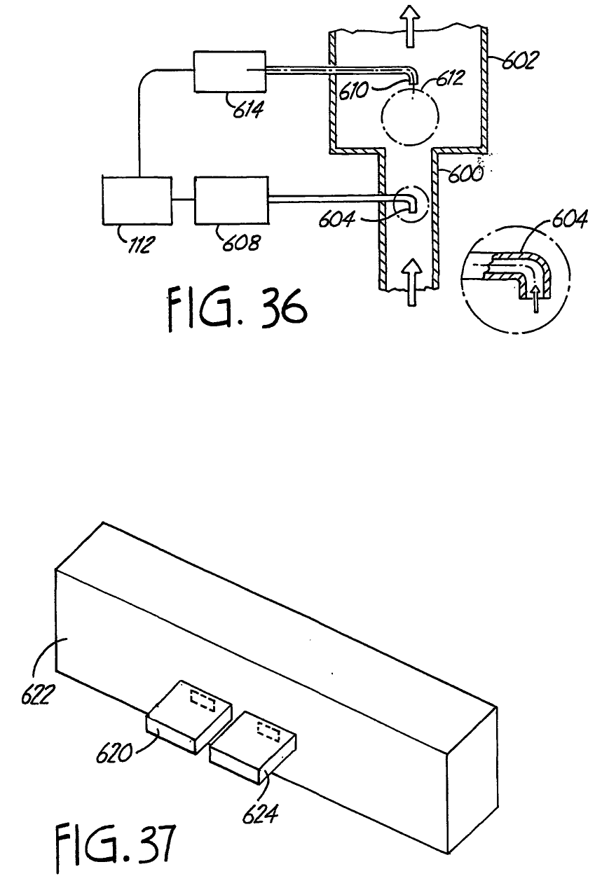

Besides maintaining the chamber pressure at a desired value, it is desirable to maintain the relative amounts of the reactants to be constant. While in principle the flow of each reactant can be measured, it is difficult to obtain an extremely accurate mass flow reading, especially with aerosol reactants. Alternatively, a small portion of the reactant stream can be removed for evaluation. Referring to FIG. 36, reactant inlet 600 directs a reactant stream into reaction chamber 602. A small sampler, spoon or tube 604 directs a small portion of the reactant stream to a mass spectrometer 608, such as a quadrapole mass spectrometer. The mass of the reactants are evaluated to determine the flux of reactants in the reactant stream. The measurements of the mass spectrometer can be used in a feedback loop to regulate the flow of reactants using controller 112 or another processor. The feed into the mass spectrometer preferably includes a filter to remove any particles from the stream. For aerosol reactants, the droplet size can be measured optically through a window directed toward the reactant stream. The atomizer parameters, such as pressure, flow, etc., can be adjusted in a feedback loop to maintain a desired droplet size in the reactant stream.

Similarly, reaction chamber 602 can include a particle sampler 610 to draw a small portion of the product particles from reaction chamber 602. Particle sampler 610 is located down stream from reaction zone 612. Sampler 610 connects with a particle size analyzer 614. Suitable particle size analyzers include, for example, a Microtrac UPA instrument from Honeywell based on dynamic light scattering and ZetaSizer Series of instruments from Malvern based on Photon Correlation Spectroscopy. The sampled particles are deposited into a liquid for the performance of the particle size analysis by these approaches. Particle size analyzer 614 also can be connected to controller 112 or to a separate processor such that the information on particle size can be used to control the reaction conditions.

The conditions in the reaction zone can be directly monitored to ensure that the heat and other forms of energy in the reaction zone remains relatively constant. To monitor the heat and other forms of energy as well as the characteristics of the chemical species in the reaction zone, a spectrometer, preferably a spectrophotometer, can be used to monitor the electromagnetic emissions from the reaction zone. A spectrophotometer is an instrument that measures the intensity of radiation at a plurality of frequencies, generally many frequencies and preferably greater than 10. Referring to FIG. 37, a light monitor 620 is mounted on elongated reaction chamber 622. For preferred embodiments with an infrared light source, light monitor 620 is an infrared monitor. An infrared monitor can include a filter to pass only infrared light and a photodetector sensitive only to infrared light. Alternatively, an infrared monitor can include a grating or prism to spread the infrared light to provide for frequency dependent measurements. The frequency dependent measurements can be used to evaluate the heat absorption in the reaction zone. Alternatively, the measurements of a light meter can be used for adjustment of laser intensity assuming that the reactant flux and other reaction conditions are constant. The laser intensity can be adjusted also based on measurements of pressure and/or reactant flow rates.

The heat in the reaction zone can be adjusted by altering the laser intensity, the concentration of inert compounds, such as argon, or the concentration of laser absorbing material. In particular, fluctuations in the light intensity measurements can be used to regulate the light source intensity. For example, if infrared measurements drop, the light source intensity can be increased to return the infrared intensity to nominal values, and vice versa. This approach is especially useful as part of a complete monitoring program such that fluctuations in the light intensity can be attributed to light fluctuations rather than reactant flux variations. The adjustment of light intensity can be performed using controller 112 interfaced with light source 110.

While laser pyrolysis tends to produce highly uniform product particles, with the combination of features described herein including the regulation of total pressure, reactant flux and light source intensity, the uniformity of the product particles can be increased further. This regulation of reaction parameters may be especially important for the production of commercial quantities of particles so that the product properties do not vary significantly with time during a production run. Furthermore, for certain applications the uniformity of the particles may be critical. Thus, approaches that can increase the uniformity of the product particles to even higher standards can have important commercial ramifications.

The nature of the product particles depends on the reaction conditions. Certain materials have extremely varied and complex phase diagrams that may involve several different oxidation states and a variety of crystal structures. In addition, the physical properties of the particles can vary. It can be painstaking work to correlate the reaction conditions with the properties of the product particles. Any approach to facilitate this process would be extremely valuable.

An efficient approach to correlate reaction conditions with product particle properties makes use of an infrared, visible and/or UV spectrometer 624, preferably a spectrophotometer, mounted on reaction chamber 622. Spectrometer 624 can be designed to measure light from the reaction zone, where the light beam intersects the reactant stream, or the region just outside of the reaction zone, where the reaction products are emitting light during their quench. In either case, the spectral features of the emissions can be correlated with the properties of the product particles. The emissions from the reaction zone, the product particles and/or the reactive species are indicative of the reactions taking place and the products being formed. Alternatively, the spectrometer can be used to measure absorption or raman scattering by the reactant stream, at the reaction zone or before or after the reaction zone. Using emissions, absorptions and/or scattering frequencies, the phase diagram as a function of reaction parameters can be mapped out in a systematic way.

Then, the correlation between optical properties, such as spectral features due to emission, absorption and/or raman scattering, and product properties can be used to adjust reaction conditions within a particular reaction chamber. Relevant reaction conditions include, for example, chamber pressure, reactant flow rates, composition of the reactant stream and light intensity. In particular, the observation of certain spectroscopic optical properties can be used to predict the properties of the product particles without the need to immediately perform complicated particle measurements such as x-ray diffraction and electron microscopy.

Correlation of spectroscopic properties with particle properties can be especially useful in scaling up production. The scale-up can take place on a particular apparatus where the reactant flux is significantly increased during scale-up or on a different apparatus that is specifically designed for high production rates. Spectroscopic measurements can provide information on reaction conditions and particle production that is approximately independent of the reaction chamber design, such that appropriate reaction chamber parameters can be adjusted more quickly to yield desired product particles.

The embodiments described above are intended to be illustrative and not limiting. Additional embodiments are within the claims below. Although the present invention has been described with reference to preferred embodiments, workers skilled in the art will recognize that changes may be made in form and detail without departing from the spirit and scope of the invention.

1. A particle production apparatus comprising:
a reaction chamber;
a reactant inlet defining a reactant path through the reaction chamber, the reactant inlet being connected to a reactant delivery system, wherein the reactant inlet has a configuration selected from the group consisting of a generally rectangular with a width being substantially greater than the width of an incident beam along the light path, generally elliptical with the reactant stream covering a significant fraction of the cross sectional area of the reaction chamber, and a pie wedge; and
optical elements defining a light path through the reaction chamber that intersects the reactant path, where the light path through the reaction chamber does not follow a single straight line path.

2. The particle production apparatus of claim 1 wherein the reactant inlet is generally rectangular, with the width of the reaction chamber being substantially greater than the width of an incident light beam directed along the light path.

3. The particle production apparatus of claim 1 wherein the reactant inlet is generally elliptical.

4. The particle production system of claim 1 wherein the optical elements comprise a reflector.

5. The particle production system of claim 1 wherein the optical elements comprise two reflectors generally facing each other.

6. The particle production system of claim 5 wherein the reflectors are flat mirrors.

7. The particle production system of claim 5 wherein at least one reflector is curved.

8. The particle production system of claim 1 wherein the reactant inlet moves such that reactants are directed to different portions of the reaction chamber.

9. A particle production apparatus comprising:
a reaction chamber;
a reactant inlet defining a reactant path through the reaction chamber, the reactant inlet being connected to a reactant delivery system;
a light source; and
optical elements directing a light beam from the light source through the reaction chamber that intersects the reactant path, the optical elements comprising a focusing element and a collimating element.

10. The particle production apparatus of claim 9 wherein the focusing element comprises a defocusing spherical lens.

11. The particle production apparatus of claim 9 wherein the collimating optics comprise telescope optics.

12. The particle production apparatus of claim 9 wherein the focusing element comprises a cylindrical lens.

13. The particle production apparatus of claim 9 wherein the light source is a laser.

14. The particle production apparatus of claim 9 wherein the light beam at any point along the reaction zone has a maximum thickness along the reactant flow path less than about a factor of ten larger than the minimum thickness value.

15. A particle production system comprising:
a reaction chamber having a reactant inlet connected to a reactant delivery apparatus oriented to produce a reactant stream within the reactant chamber; and
optical elements positioned to direct two approximately parallel light beams, where the reactant stream is intersected by at least one light beam.

16. The particle production system of claim 15 wherein the reaction chamber comprises a second reactant inlet such that the first inlet generates a reactant stream that intersects one of the light beams while the second inlet generates a reactant stream that intersects the other light beam.

17. The particle production system of claim 15 wherein the optical elements comprise a beam splitter.

18. The particle collection system of claim 15 wherein the optical elements comprise two reflectors.

19. The particle collection system of claim 15 wherein the reaction chamber comprises a second reactant inlet such that the first reactant inlet and the second reactant inlet generate reactant streams that are intersected by both light beams.
